(19) United States
(12) Patent Application Publication
(10) Pub. No.: US 2024/0062667 A1
(43) Pub. Date: Feb. 22, 2024

(54) SYSTEM AND METHOD FOR ASSIGNING TRAINING BASED ON BEHAVIOR DATA

(71) Applicant: Safety Holdings, Inc., Greenwood Village, CO (US)

(72) Inventors: Patrick Kemble, Greenwood Village, CO (US); Amy Wilson, Greenwood Village, CO (US); Aaron Purvis, Greenwood Village, CO (US); Daniel Laney, Greenwood Village, CO (US)

(73) Assignee: Safety Holdings, Inc., Greenwood Village, CO (US)

(21) Appl. No.: 18/187,568

(22) Filed: Mar. 21, 2023

Related U.S. Application Data
(60) Provisional application No. 63/362,255, filed on Mar. 31, 2022.

(51) Int. Cl. G09B 5/02; G06F 18/22

(52) U.S. Cl. CPC G09B 5/02; G06F 18/22

(57) ABSTRACT

Methods and systems for assigning and providing training based on assessing the behavior data of an operator and electronic training content. The methods and systems may utilize algorithms to process and evaluate the driver behavior data and electronic training content and to assign electronic training content to the operator. The methods and systems for assigning and providing training may be modified based on changing behavior data of the operator and the effectiveness of previously assigned electronic training content.

### CROSS REFERENCE TO RELATED APPLICATION

The present application claims the benefit of U.S. Provisional Application Ser. No. 63/362,255, filed Mar. 31, 2022, entitled “TRAINING ASSIGNMENT BASED ON BEHAVIOR DATA” which is incorporated herein by reference. To the extent appropriate, a claim of priority is made to each of the above disclosed applications.

### FIELD OF INVENTION

The present disclosure generally relates to training. More particularly, the disclosure is related to assessing the behavior data of an operator to determine a training assignment to assign to that operator.

### BRIEF DESCRIPTION OF THE DRAWINGS

FIG. 1 depicts an environment in accordance with examples of the present disclosure;

FIG. 2 depicts a server deployed or executed in an environment in accordance with examples of the present disclosure;

FIG. 3 depicts an example of a computer system upon which a server, computer, computing device, or other system or components may be deployed or executed in accordance with examples of the present disclosure;

FIG. 4A depicts an example of a server receiving information including driver behavior data in accordance with examples of the present disclosure.

FIG. 4B depicts an example of a server receiving information including driver behavior data in accordance with examples of the present disclosure.

FIG. 4C depicts an example of a server receiving information including driver behavior data in accordance with examples of the present disclosure.

FIG. 5 depicts an example signaling process in accordance with examples of the present disclosure;

FIG. 6 depicts an example signaling process in accordance with examples of the present disclosure;

FIG. 7A depicts a data structure that can be sent, received, stored, retrieved, etc. in accordance with examples of a the present disclosure;

FIG. 7B depicts a data structure that can be sent, received, stored, retrieved, etc. in accordance with examples of the present disclosure;

FIG. 7C depicts a data structure that can be sent, received, stored, retrieved, etc. in accordance with examples of the present disclosure;

FIG. 8A depicts an example method associated with assigning training based on behavior data in accordance with examples of the present disclosure;

FIG. 8B depicts an example method associated with assigning training based on behavior data in accordance with examples of the present disclosure;

FIG. 9 depicts an example user interface in accordance with examples of the present disclosure; and

FIG. 10 depicts an example method associated with completing training using the user interface shown in FIG. 9.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Although computer-based training is used in many learning situations including educational institutions, businesses, and government, one particular area of training has proved very beneficial. This particular area is in operator training, including, for example, for an operator of a vehicle. Operator or driver training is often provided to new operators/drivers before the operator/driver has the opportunity to operate an actual vehicle. For example, before actually driving on roads with other drivers, high school students are often provided in-class training covering the basic fundamentals of operating an automobile. This training helps the new driver understand the operation of the target vehicle (e.g., how and when to turn on the lights, wipers, which pedal is the brake and which is the gas, etc.). Such training is often computer-based training with a fixed, scripted lesson. Each student that is taking driver education receives the same lesson and the lesson is often repeated until sufficient comprehension is achieved.

As for remedial training, often after an accident or a moving violation a driver involved in the incident may be provided an opportunity to remove the accident or moving violation from their driving record by taking a remedial drivers educational course. This training is offered as computer-based training and is often provided online (e.g., through the Internet). Such training has a fixed, scripted lesson. However, the driver who made an illegal left turn and the driver who was ticketed for speeding are presented with the same scripted lesson.

Many professions may offer computer-based training for operators of motor vehicles, boats, planes, trains, motorcycles, military vehicles, trucks, etc. This training typically consists of pre-scripted lessons progressing in an orderly fashion from basic principles and operation to more complex subjects. For example, computer-based training for a truck driver begins with basic operation of the target vehicle and progresses to more the complicated aspects of operation, accident avoidance, operating under adverse weather, etc.

Complications arise when an operator finishes the computer-based training, completes behind the wheel training, becomes certified to operate the target vehicle and operates such a vehicle in the course of their employment, and subsequently has something happen including, for example, an accident or moving violation. The accident or moving violation may occur due to poor, incorrect, or otherwise undesired driver behavior(s). For example, a driver may repeatedly driver faster than the speed limit, not focus on their driving, ignore posted warning signs, and other potentially dangerous behaviors. Often, for state or federal requirements or for insurance/liability requirements, the employing company needs to provide remedial training to demonstrate that they recognize the issue and are taking steps to prevent the issue from occurring again in the future. In the past, companies have used the same computer-based training offered during the initial operator training as remedial operator training. This technique is wrought with tedium and boredom, in that the operator often knows most of the content and is only having problems with one specific area. For example, the accident or moving violation may occur due to undesired behavior of the operator. This scenario is similar to the prior example, in which all drivers are provided a pre-designed course to take after receiving any type of moving citation. It does not concentrate on the issue or undesired behavior and therefore, is less effective in correcting the issue or undesired behavior.

Vehicles can be equipped with sensors including, for example, dashboard cameras, speed sensors, accelerometers, and more. Use of these sensors would likely help improve operator safety, but the data from these sensors is often not used to determine a training assignment to correct unsafe driving behavior. Still, data from these sensors can provide vastly superior operator feedback and training, especially after an accident has occurred.

Additionally, undesired behavior can be better determined using behavior data collected from incident and other action reports. For example, data may be collected by a regulatory entity including, for example, motor vehicle reports from government agencies, claims data collected by insurance agencies, and court data related to undesired behaviors. A motor vehicle report can provide insight into the behavior of the operator from the collected data related to traffic violations, accidents, convictions, crimes, and other information related to the operator. Claims data can provide additional insight into accidents that an operator is involved in, including the cause of the accident. Court data can provide additional insight into driver behavior data through data including, for example, convictions related to the operation of the vehicle and other driver behavior that can lead to undesired operation of a vehicle.

Electronic training content may be changing, updating, and being added to, leading to the most useful or effective electronic training content for an operator to change. Driver behavior data is also constantly changing, updating, and being added to. The changing driver behavior data similarly changes which electronic training content that may be most useful or effective to train the operator. Furthermore, once an operator completes training, the operator may have understood and passed the training, struggled with the training topic and barely passed or failed the training, or completely failed the training topic. The operator's performance during assigned training may also affect what training is most useful or effective. Ineffective training content, including content that is completed but does not change the unwanted driver behavior, can be assigned less or not at all, and effective training content, including content that effectively changes the unwanted driver behavior, can be assigned to more drivers exhibiting the unwanted driver behavior in the future. The training system may also need to adjust a type of training based on how each individual operator effectively learns. One type of training content may be effective to certain operators while being ineffective for other operators.

What is needed is a system that will deliver directed remedial training based upon behavior data, e.g., data related to operator behavior and data related to an incident that can determine the most useful or effective training. The system should be able to determine and update the determination of training to be assigned to an operator based on driver behavior data and operator performance in previously completed training. The system may also need to process and evaluate large amounts of driver behavior data and electronic training content quickly to ensure that each driver who exhibits unwanted driver behavior receives timely training to correct the unwanted driver behaviors before accidents and/or other issues occur.

The described system pertains to any type of computer-based training for any target person. Throughout this description, the target of the training assignment is directed to a target person who is a driver. The described system is equally applicable to any other type of operator, including operators of any type of vehicle (cars, motorcycles, boats planes, fork-lifts, etc.) and operators of practically anything including, for example, machinery (Computer Numerical Control (CNC) machines, cash registers, etc.), etc. The described system is anticipated for use in any training in which an operator's (e.g., driver) behavior data is received or otherwise collected, and the behavior data is analyzed or otherwise used to determine training that should be assigned to the operator to correct undesired behavior. For example, if an operator of a vehicle repeatedly drives faster than the posted speed limit, the described invention will provide directed, remedial training related to speeding, the particular undesired behavior associated with the operation of a vehicle.

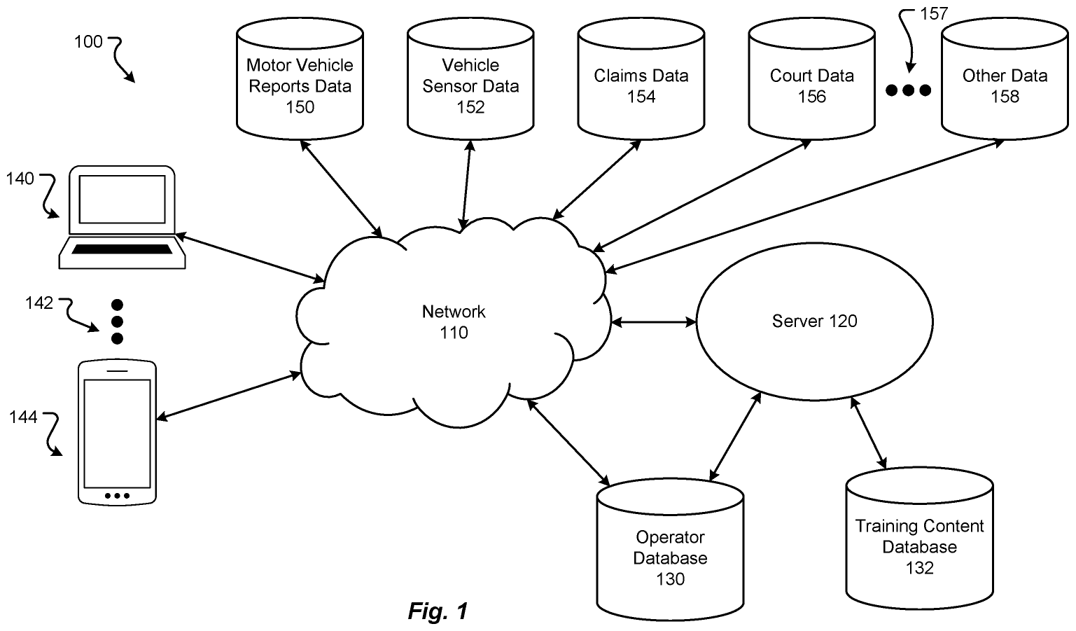

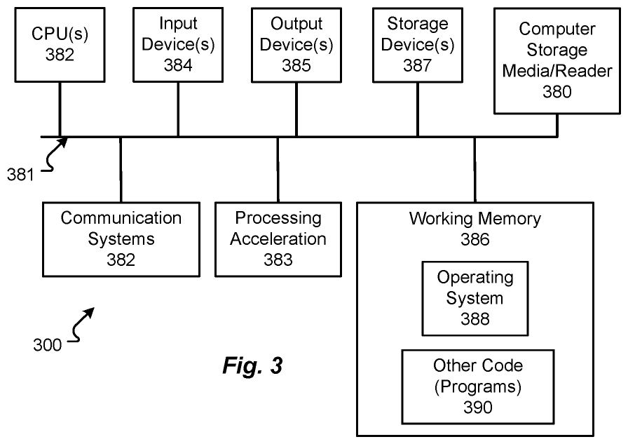

An example of an environment 100 where the methods and processes herein may be conducted may be as shown in FIG. 1. The environment 100 may include servers, user computers, computing devices, databases, or other systems provided and described herein, in accordance with examples of the present disclosure. While some systems of FIG. 1 may be described as a server, user computer, database, or other systems, one or more systems of FIG. 1 may be different types of systems in other examples. The systems in environment 100 may be as shown and described in FIG. 3.

The environment 100 can include computing devices 140, 142, 144. The computing devices 140, 142, 144 may include general purpose personal computers (including, merely by way of example, personal computers, and/or laptop computers running various versions of Microsoft Corp.'s Windows®, Google's Android Operating System (OS), Linux OS, and/or Apple Corp.'s MacOS or iOS® operating systems) and/or workstation computers running any of a variety of commercially-available UNIX® or UNIX-like operating systems. These computing devices 140, 142, 144 may also have any of a variety of applications, including, for example, database clients and/or server applications, and web browser applications. Alternatively, the computing devices 140, 142, 144 may be any other electronic device, for example, a thin-client computer, Internet-enabled mobile telephone, and/or personal digital assistant, capable of communicating via a network 110 and/or displaying and navigating web pages or other types of electronic documents. Although the exemplary computing environment 100 is shown with two computing devices, any number of user computers or computing devices may be supported as indicated by the ellipses 142.

The computing environment 100 may also include one or more servers 120. The server 120 may be a server provided in a cloud computing environment, for example, in Amazon® Web Services™ (AWS), Google® Cloud® Platform, Microsoft® Azure®, etc. The web server 120 can be running an operating system, including any commercially-available server operating systems. The server 120 can also run a variety of server applications, including Session Initiation Protocol (SIP) servers, HTTP(s) servers, File Transfer Protocol (FTP) servers, Common Gateway Interface (CGI) servers, database servers, Java servers, and the like. In some instances, the server 120 may publish available operations as one or more web services.

The server 120 may also include one or more applications accessible by a client running on one or more of the computing devices 140, 142, 144. In at least some configurations, the server 120 can provide data to the computing devices 140, 142, 144 and receive data from these computing devices 140, 142, 144. The server 120 may be one or more general purpose computers capable of executing programs or scripts in response to the computing devices 140, 142, 144. As one example, the server 120 may execute one or more web applications. The web application may be implemented as one or more scripts or programs written in any programming language, for example, Java®, JavaScript, Go, R, Swift, C, C #®, or C++, and/or any scripting language, for example, Perl, Hypertext Preprocessor (PHP), Python, or Transaction Control Languages (TCL), as well as combinations of any programming/scripting languages. The server 120 may also include database servers, including without limitation those commercially available from Oracle®, Microsoft®, Sybase®, IBM® and other current or future-developed database technologies, which can process requests from database clients running on a computing device 140, 142, 144.

The server 120 may forward web pages, created by the server 120, to a computing device 140, 142, 144. Similarly, the server 120 may be able to receive web page requests, web services invocations, and/or input data from a computing device 140, 142, 144 (e.g., a user computer, etc.) and can forward the web page requests and/or input data to the) server 120. Although for ease of description, FIG. 1 illustrates a single server 120, those skilled in the art will recognize that the functions described with respect to server 120 may be performed by a plurality of specialized servers, depending on implementation-specific needs and parameters.

The environment 100 may also include a databases and/or external data sources including, for example, 130, 132, 150, 152, 154, 156, 157, 158. As used herein, an external data source is a source of data that is external to the training assignment system Thus, the external data sources can include the operator database 130 and the training content database 132. The databases may reside in a variety of locations. By way of example, the databases may reside on a storage medium local to (and/or resident in) one or more of the computing devices 140, 142, 144. Alternatively, it may be remote from any or all of the computing devices 140, 142, 144, and in communication (e.g., via the network 110) with one or more of these systems. The databases may reside in a Storage-Area Network (“SAN”) familiar to those skilled in the art. Similarly, any necessary files for performing the functions attributed to the computing devices 140, 142, 144 may be stored locally on the respective computer and/or remotely, as appropriate. The databases may be relational databases that are adapted to store, update, and retrieve data in response to Structured Query Language (SQL)-formatted commands. The databases and/or external data sources including, for example, external sources 130, 132, 150, 152, 154, 156, 157, 158 may represent databases and/or data stores.

The server 120 may be in communication. through the network 110, with one or more computing devices 140, 142, 144. The computing devices 140, 142, 144 may access the server 120 through a web-based application. The web application may be a software as a service (SaaS) application that allows the user to access training assignments. The server can include any hardware, software, or hardware and/or software operable to select training for the user associated with the computing device 140, 142, 144 and provide the training to the computing device 140, 142, 144. The computing device 140, 142, 144 can be hardware, software, or a combination of hardware and software. Devices, components, systems, computers, etc. that may represent the computing device 140, 142, 144, or server 120 may be as shown and described in FIG. 3.

The server 120 may also be in communication, through a network 110, with one or more external sources of information about the drivers. These external information sources can be databases, data stores, or systems that store information. The external information sources can include one or more of motor vehicle reports data 150, vehicle sensor data 152, claims data 154, court data 156, additional data sources represented by ellipses 157, and other data 158. The external data sources 150 through 158 may be databases, servers including websites hosted on servers, another type of data store, or a combination of the data sources. Each of these external data sources 150 through 158 can be hardware, software, or a combination of hardware and software. The external data sources 150 through 158 may be computers, devices, etc., as described in conjunction with FIG. 3.

The motor vehicle reports data 150 can provide traffic tickets, non-moving violation tickets, or other information about the Motor Vehicle Records (MVRs) of the driver. The motor vehicle reports data 150 may be a system, database, or some other data store associated with the Department of Motor Vehicles. The vehicle sensor data 152 may provide any type of information about the state of one or more vehicles including, for example, speed, turning instances, accident occurrences, dashcam footage, and other vehicle information. The data provided by vehicle sensor data 152 may be telematics events datapoints including, for example, hard braking, unsafe turns, speeding, and other telematics events recorded by vehicle sensors. The vehicle sensor data 152 may be a system, database, or some other data store that receives the sensor information from one or more vehicles. In some examples, the vehicle sensor data 152 is a system, database, or some other data store that is part of the vehicle the sensors are collecting data for. The claims data 154 may provide any type of information about insurance claims including, for example, claims related to a vehicle accident. The data provided by the claim data 154 may be referred to as claim datapoints. The claims data 156 may be a system, database, or some other data store associated with one or more insurance companies. The court data 156 may provide any type of information about plea bargains or convictions on tickets or other types of crimes. The data provided by the court data 156 may be referred to as court datapoints. The court data 156 may be a system, database, or some other data store associated with one or more courts including state courts and federal courts. The additional data sources 157 and/or other data 158 can include other information. The additional data sources 157 and/or other data 158 may be a system, database, or some other data store.

The server 120 may also interact with operator database 130. The operator database 130 can store the information from external data sources 150 through 158 or data provided by computing devices 140 through 144. The computing devices 140 through 144 may be used to provide customer provided crash data, which can include any type of crash or other information about a driver and about an accident or other incident that occurred. This information may be stored in operator database 130. The operator database 130 may be as described in conjunction with FIG. 3.

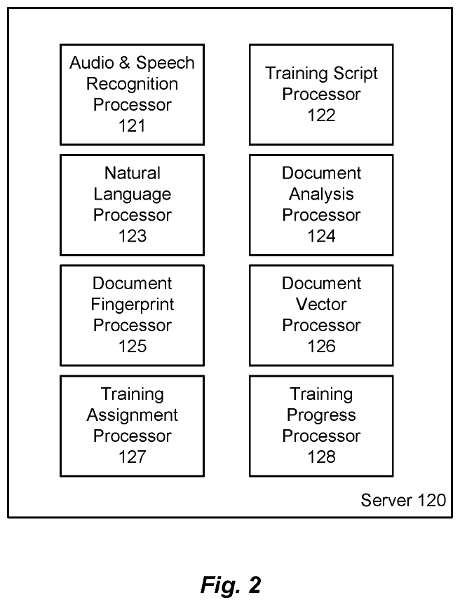

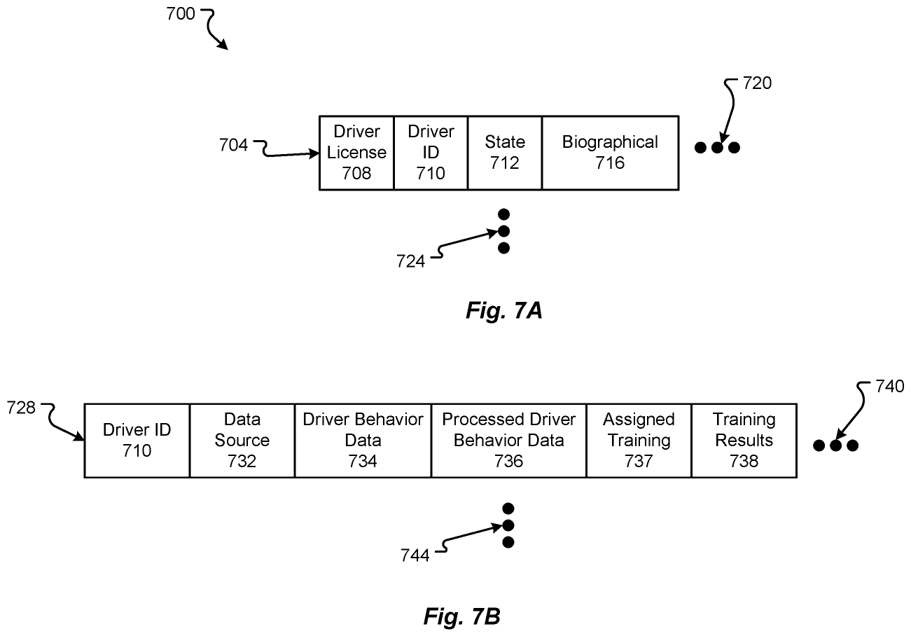

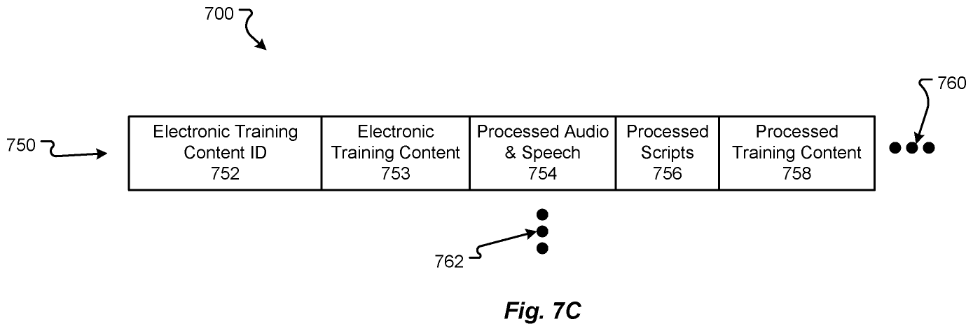

The operator database 130 may store any type of driver information and/or driver behavior data. The driver behavior data can include any type of data that indicates driver behavior, including the information provided by insurance companies or other organizations that describe how the driver is performing including, for example, the information provided by external data sources 150 through 158. The driver behavior data received by the server 120 may be in a form that is ready to be processed by natural language processing, such as by natural language processor 123 shown in FIG. 2 and described in more detail herein. For example, court data, claims data, and motor vehicle reports data are commonly in textual form and ready for natural language processing. Additionally, vehicle sensor data can be sent in a textual form that is ready for natural language processing. In other examples, the data may be processed by the server 120 to be prepared for natural language processing. At least some of this information may be as described in conjunction with FIGS. 7A and 7B. There may be other sources of information not shown in FIG. 1.

FIG. 2 depicts a server 120 deployed or executed in an environment in accordance with examples of the present disclosure. The server 120 in this example includes an audio & speech recognition processor 121, training script processor 122, natural language processor 123, document analysis processor 124, training assignment processor 127, and training progress processor 128. The server 120 may include fewer or more processors and/or other components in other examples. The processors 121, 122, 123, 124, 125, 126, 127, 128 may be general purpose processors that execute instructions, which may be stored in memory, to perform the actions described herein or special purpose processors designed to perform the actions described herein. Devices, components, systems, computers, etc. that may represent the processors 121, 122, 123, 124, 125, 126, 127, 128 may be as shown and described in FIG. 3. In some examples, a single processor may be used to perform the actions of one or more of the processors 121, 122, 123, 124, 125, 126, 127, 128, but the processors will be referred to as separate processors herein for clarity.

The processors 121, 122, 123, 124, 125, 126, 127, 128 can read, retrieve, and/or store data stored by the server 120, data stored by and/or received from external data sources including, for example, external data sources 150, 152, 154, 156, 157, 158, data stored by and/or received from operator database 130 and training content database 132, and/or data received from computing devices 140, 142, 144.

The audio & speech recognition processor 121 processes data including, for example, electronic training content. The audio & speech recognition processor 121 may receive or otherwise access electronic training content stored by the training content database 132. Processing the data includes identifying any audio and/or speech included in the data, including, for example, the audio portion of a video form of electronic training content and the audio of an audio form of electronic training content. The processed audio and/or speech may be translated or otherwise configured into information that one or more of the processors of the server 120 can subsequently use for determining electronic training content to be assigned to a driver. In an example, the translated information is textual.

The audio & speech recognition processor 121 may additionally process other types of data including, for example, driver behavior data. For example, the audio & speech recognition processor 121 receives or otherwise accesses driver behavior data stored by external data sources 150-158, operator database 130, and/or computing devices 140-144. One type of driver behavior data may be a recording made by a dashboard camera operated in a vehicle associated with a driver. The audio & speech recognition processor 121 may process the audio portion of the recording to produce information that one or more processors of the server 120 including, for example, natural language processor 123, can use to determine electronic training content to be assigned to the driver. For example, the dashboard camera may convert the noise in the cabin of the vehicle into textual information. In an example, the driver may be talking on a telephone, and the textual information produced from the audio of the dashboard camera may be used to identify that the driver is using the telephone while driving. In this example, the processors may use this information to determine that the driver should be assigned training related to the dangers of distracted driving.

The audio & speech recognition processor 121 may cause the server 120 to store the processed data and/or send the processed data to be stored externally, for example, by the operator database 130 and/or the training content database 132.

The training script processor 122 processes data including, for example, textual data. The textual data may be data included in electronic training content including, for example, the script of the electronic training content, training literature, and examination questions and answers. The training script processor 122 may receive or otherwise access electronic training content stored by the training content database 132. The textual data may be translated or otherwise configured into information that one or more of the processors of the server 120 including, for example, the natural language processor 123, can subsequently use for determining electronic training content to be assigned to a driver.

The training script processor 122 may cause the server 120 to store the processed data and/or send the processed data to be stored externally including, for example, by the operator database 130 and/or the training content database 132.

The natural language processor 123 performs natural language processing on textual data. For example, the natural language processor 123 performs natural language processing on driver behavior data that is textual data and/or data processed by the audio & speech recognition processor 121 and/or the training script processor 122 to be converted into textual data. The natural language processor 123 may receive or otherwise access textual data stored by the server 120, the external data sources 150-158, the operator database 130, the training content database 132, and/or the computing devices 140-144.

The natural language processor 123 may use any natural language processing algorithm to process the data. For example, the natural language processor 123 may use algorithms including Term Frequency-Inverse Document Frequency (TF-IDF) algorithms, support vector machines, Bayesian networks, maximum entropy, conditional random fields, neural networks, machine learning algorithms, Edit distance, and Naïve Bayes. In an example, the natural language processor 123 uses TF-IDF. TF-IDF includes processing data to determine the importance of one or more words in the data. Each relevant word in the data is assigned a value that indicates the importance of the word. The value assigned to each word increases proportionally to the number of times the word appears in the data and is offset by the number of data pieces. For example, the number of data pieces when processing electronic training content is the number of electronic training content files stored in the training content database 132. The offset adjusts the value for the fact that some words including, for example, “the” “if” “or” and so on, appear more frequently in general and may not be useful in indicating the content of the data.

To apply TF-IDF and/or another algorithm, the natural language processor 123 tokenizes the data. Tokenizing the data includes creating tokens by separating the text of the data into one or more units. The tokens can be words, characters, subwords (e.g., “speeding” tokenized into “speed” and “ing”), and/or some other portion of the data. Textual data is commonly tokenized using a space as a delimiter. For example, the string “speeding is against the law” can be tokenized into “speeding” “is” “against” “the” “law”. Once the tokens are created, the natural language processor 123 can perform TF-IDF using the tokens to determine and/or assign a value for at least one token or each token.

The natural language processor 123 assigns the value to the words in the data and stores the processed and tokenized data including the values. In an example, the data may be electronic training content with high values assigned to the words “speed”, “limit”, and “speeding”. This indicates that the electronic training content is associated with training related to speeding. The processed data can be used by other processors of the server 120 including, for example, the document analysis processor 124, when assigning electronic training content to a driver. The natural language processor 123 may store the tokenized and processed data in the server 120 and/or send the processed data to be stored externally, for example, by the operator database 130 and/or the training content database 132.

Tokenized data as used herein refers to data processed by the natural language processor 123. For example, tokenized electronic training content is electronic training content processed by the natural language processor 123, and tokenized driver behavior data is driver behavior data processed by the natural language processor 123. A single tokenized electronic training content document is a tokenized electronic training document, and a single tokenized driver behavior document is a tokenized driver behavior document. Therefore, tokenized data may be tokenized to produce tokens and processed using an algorithm, for example, TF-IDF.

As used herein, a document is a file of data of any type. The document can include driver behavior data and/or electronic training content. For example, a driving citation is a driver behavior document. A video about the dangers of speeding is an electronic training content document. Each document that is electronic training data may be related to or otherwise associated with a specific topic related to driving. For example, the training content database 132 may store one or documents directed to speeding, one or more documents directed to unsafe turning, one or more documents directed to yielding, and one or documents directed to other topics related to driving.

Each document that is driver behavior data may be a document containing driver behavior data related to a driver. There may be multiple documents related to a single driver or all of the data for the driver may be compiled into a single document. Example driver behavior data documents include court data, motor vehicle reports data, claims data, vehicle sensor data, and documents related to other topics related to driver behavior.

The document analysis processor 124 processes documents to prepare data for comparison including, for example, the tokenized data produced by the natural language processor 123. For example, the document analysis processor 124 determines one or more topics associated with the document and/or the document is directed to, determines one or more ranks of the document, creates a document vector, and/or creates a document fingerprint. The document analysis processor 124 may use any algorithm including the algorithms discussed above to process the documents. The rank(s) of the document may be a value that is assigned to each document that indicates the relevance, detail, and/or other property of the document for each topic that is associated with the document. For example, an electronic training content document may be recently published content that includes detailed and updated information on navigating a roundabout, a short paragraph regarding wearing a seatbelt, and a medium length paragraph related to speeding. The document may be assigned a high rank for the roundabout navigation topic, a medium rank for the speeding topic, and a low rank for the seatbelt topic. There may be a minimum and maximum rank. For example, a rank of zero or no rank may be the minimum rank, indicating that the document is not relevant to the topic if the document has a rank of zero or no rank. The maximum rank may be a value of one hundred, indicating that the document is the most relevant or otherwise useful document regarding the topic if the document has a rank of one hundred.

The document analysis processor 124 may create the document vector based on the topic associated with the document and/or the rank. The document vector for each document that the document analysis processor 124 creates can be based on the one or more topics the document is directed to, the one or more ranks of the document, and/or other properties and/or the contents of the document. The document vector may be used to compare the documents by processors including, for example, training assignment processor 127, without needing to evaluate the entire content of the document. In examples, the document vector may be any number n-dimensional vector. Each dimension may be related to a topic of the document and/or any property of the document, and/or other content indicator of the document.

For example, an electronic training content document may be recently published content that includes detailed and updated information on navigating a roundabout, a short paragraph regarding wearing a seatbelt, and a medium length paragraph related to speeding. The document may already be assigned a rank for each electronic training topic as discussed above. The document analysis processor 124 may create an electronic training content vector for the example electronic training content document that has at least three dimensions, with one dimension being the roundabout navigation topic, one dimension being the speeding topic, and one dimension being the seatbelt topic. The roundabout navigation dimension may be assigned a high value to indicate the relevance of the document on the roundabout navigation topic. Similarly, the speeding dimension may be assigned a medium value and the seatbelt dimension may be assigned a low value.

A document vector for driver behavior data, a driver behavior data vector, may include one or more documents of driver behavior data for a driver. For example, one document vector may be based on court data of a Driving Under The Influence (DUI) citation the driver received, a speeding ticket from motor vehicle reports data, vehicle sensor measurements indicating speeding, and an accident claim from an insurance company. The document vector for the driver may be created based on one or more of this driver behavior data. If the document vector is created using all of the driver behavior data, the vector may be at least a two dimensional vector including (1) a dimension for driving under the influence assigned a value that corresponds to at least the DUI citation; (2) a dimension for speeding assigned a value that corresponds to at least the speeding ticket and the vehicle sensor measurements; and, potentially, (3) a dimension for a topic that is the cause of the accident detailed in the accident claim. The driver behavior data may be used for assigning a value to multiple dimensions. For example, the accident may have been caused by a combination of speeding and unsafe turning. The accident claim could therefore be used for assigning a value to the dimension for speeding and a dimension for unsafe turning. In other examples, each driver behavior data document may have its own document vector. For example, the accident claim vector would be at least two dimensions including the speeding dimension and the unsafe turning dimension.

When comparing the document vectors, as will be explained in further detail herein, a processor, for example the training assignment processor 127, may compare or otherwise evaluate electronic training content vectors and driver behavior data vectors to select training relevant to a driver. For example, the training assignment processor 127 may compute the difference between the vectors in the n-dimensional space to determine the relevance of electronic training content to the driver behavior data. Typically, the lower the distance between the vectors, the more relevant the documents' contents are. However, assigning training may be based on a specific topic, and the processor assigning the training to the driver may choose to ignore certain dimensions and/or assign weights to the dimensions to focus more on certain dimensions and less on other dimensions.

In an example that does not include assigned weights to the dimensions, two electronic training content vectors and a driver behavior data vector each have a speeding dimension, an unsafe turning dimension, and a stop light dimension. The first electronic training content dimension has a speeding dimension value of two, an unsafe turning dimension value of ten, and a stop light dimension value of zero. The values assigned to the first electronic training content vector indicates that the electronic training content associated with the vector contains training mainly related to unsafe turning, has some training related to speeding, and no training related to stop lights. The second electronic training content vector has a speeding dimension value of zero, an unsafe turning dimension value of zero, and a stop light dimension of nine, indicating that the electronic training content item associated with the second vector is related only to stop lights. The example driver behavior data vector has a speeding dimension of two, an unsafe turning dimension of eight, and a stop light dimension value of zero.

Because the vectors in this example have three dimensions, the speeding dimension, the unsafe turning dimension, and the stop light dimension, the distance between the vectors is calculated using a three dimensional space. The distance between the vectors may be computed using the equation d=\sqrt{(x₁−y₁)²+(x₂−y₂)²+(x₃−y₃)²}, where d is the distance between the vectors, x is the first vector, y is the second vector, and the subscripts 1, 2, and 3, denote the dimension of each vector. In this example, x₁ and y₁ are the values of the vectors in the speeding dimension, x₂ and y₂ are the values of the vectors in the unsafe turning dimension, and x₃ and y₃ are the values of the vectors in the stop light dimension. The equation may include more or less dimensions as needed to compute the distance between the vectors. The distance between the driver behavior data vector and the first electronic training content vector would therefore be \sqrt{(2−2)²+(8−10)²+(0−0)²}=2 (two). The distance between the driver behavior data vector and the second electronic training content vector is \sqrt{(2−0)²+(8−0)²+(0−9)²}=\sqrt{149}, or about 12.2. Therefore, the distance indicates that the first electronic training content item is more relevant or otherwise useful than the second electronic training content item due to the smaller distance of two between the driver behavior data vector and the first electronic training content item vector. The training assignment processor 127 may determine that the electronic training content that the first electronic training content vector is associated with should be assigned to the driver due to the short distance that was calculated. In an example, the training assignment processor 127 may compare the calculated distances to a threshold, a value of five for example, to determine if training content should be assigned. Training content below the threshold, including the first electronic training content item that has a calculated distance of two, may be assigned to the driver associated with the driver behavior data vector.

The training assignment processor 127 may perform additional operations to ensure that relevant training content is assigned. For example, the training assignment processor 127 may typically assign training content that is a distance of less than fifteen from a driver behavior data vector. However, the driver behavior data vector indicates that the driver associated with the vector does not need training related to stop lights, and the second training content vector is related only to stop lights and has a distance of less than fifteen. The training assignment processor 127 can eliminate dimensions, assign weights to dimensions as discussed above, and/or perform other operations that ensure each driver is assigned relevant training.

In some examples, the document analysis processor 124 creates a document fingerprint for each document that the document analysis processor 124 processes. The document fingerprint can be based on the one or more topics the document is directed to, the one or more ranks of the document, the document vector, and/or other properties and/or the contents of the document. To create the document fingerprint, the document analysis processor 124 maps the document to an identifier, for example, a string. The document fingerprint uniquely identifies the document. The document fingerprint may indicate the one or more topics the document cis directed to, the one or more ranks of the document, and/or other properties and/or the contents of the document without needing to evaluate the contents of the document. Therefore, the document fingerprint may allow processors of the server 120, including, for example, training assignment processor 127, to compare or otherwise evaluate documents without needing to evaluate the entire contents of each document by comparing the document fingerprints and/or receiving information on the document by accessing or otherwise processing the document fingerprint. The document fingerprints can also identify documents when processors of the server use document vectors to perform comparisons.

In some examples, the document analysis processor 124 creates document fingerprints to protect driver information and/or to identify and track data. For example, the document analysis processor 124 can process sensitive information including, for example, court data, health information, personal information including, for example, a social security number, and other sensitive data associated with drivers and create a document fingerprint that identifies sensitive information and allows the server 120 to only send the sensitive information to secure and authorized recipients.

Data processed by the document analysis processer 124, including document vectors, document fingerprints, and/or data processed in other ways by the document analysis processor 124 may be prepared data. For example, electronic training content processed by the document analysis processor may be referred to as prepared electronic training content, and driver behavior data processed by the document analysis processor may be referred to as prepared electronic training content. A single prepared electronic training content document may be referred to as a prepared electronic training content document, and a single prepared driver behavior document may be referred to as a prepared driver behavior data document.

The training assignment processor 127 processes documents to determine relevance or some other correlation between documents and/or assigns training. The training assignment processor 127 may compare or otherwise evaluate the electronic training content vectors and the driver behavior data vectors to determine which training is relevant to a driver and subsequently assign the relevant training to the driver. The training assignment processor 127 may also compare the electronic training content fingerprints and the driver behavior data fingerprints to determine which training is relevant to a driver and subsequently assign the relevant training to the driver.

For example, the training assignment processor 127 may identify one or more driver behavior data documents associated with a driver. Driver behavior data documents that are associated with a driver are documents that detail the driver's behavior including, for example, a ticket the driver received, vehicle sensor data collected from a vehicle the driver operated, and court documents about a case the driver was involved in. The training assignment processor 127 may use the driver behavior data vectors and/or the driver behavior data fingerprints of the identified documents. The training assignment processor 127 then compares the driver behavior data with the electronic training data to determine which training is relevant or otherwise necessary for the driver.

For example, when the training assignment processor 127 uses the driver behavior data vectors and the electronic training content vectors to determine relevant training, the training assignment processor 127 does a comparison and/or other operation using the dimensions of the vectors. For example, the training assignment processor 127 may compute the distances between the driver behavior data vectors and the electronic training content vectors. In examples, there is a threshold distance that the training assignment processor 127 uses to determine which electronic training content to assign. The training assignment processor 127 may determine the driver requires no training or determine one or more electronic training content documents the system should assign to the driver.

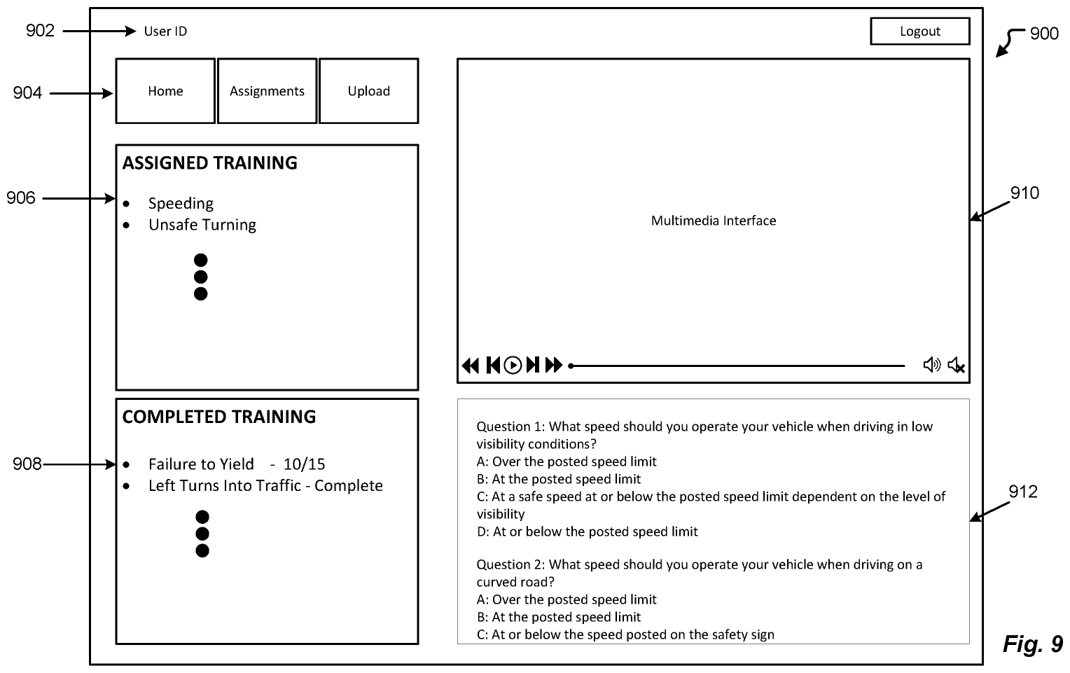

The training assignment processor 127 can send the determined electronic training content documents, notifications about new training assignments, and/or links to the electronic training content to the driver. For example, the training assignment processor 127 communicates with a computing device 140, 142, 144 that is associated with the driver to assign the training. In other examples, there is a training interface, such as the user interface shown in FIG. 9 below for example, that the driver has an account for. The training assignment processor 127 can assign the training to the account for the driver to access on a device the driver uses to access the training interface.

The training progress processor 128 monitors the progress of the assigned training. For example, the driver may complete three training assignments, passing one training with a perfect score, barely pass another training, and fail another training. The training progress processor 128 can communicate the progress and results of the training assignments to the training assignment processor 127 for the training assignment processor 127 to assign new training based on the training progress results. The training progress processor 128 can store the training progress and results as driver behavior data, be used to update existing driver behavior data and the associated vectors and/or fingerprints, and/or stored for use. Further, the training progress processor 128 can store the training progress and results in the operator database 130.

In an example, the training progress processor 128 can assign the driver training for speeding, unsafe turns, and defensive driving. The driver passes the speeding training with a perfect score, passes the unsafe turns training with an intermediate score, and fails the defensive driving training. The training progress processor 128 can monitor, store the results, and/or send the results to the training assignment processor for determination of further training. The training assignment processor 127 may use the results to update driver behavior data and/or use the results when comparing the electronic training content and the driver behavior data. For example, the training progress processor 128 may update the driver behavior data to lower the importance of training about speeding including, for example, by referencing the results, lowering the value assigned to the speeding dimension of the driver behavior data vector(s) associated with the driver, and/or altering the fingerprint to lower the speeding rank. Similarly, training assignment processor 127 may raise, lower, or keep the same the driver behavior data related to unsafe turns based on how the intermediate results are reflection of the driver learning from the training. The training progress processor 128 can raise or maintain a level for driver behavior data related to unsafe turning. In examples, the result of using the training results is that the driver may no longer need to receive training directed to speed, may still assign training related to unsafe turning, and can assign training directed to defensive driving again.

In at least some examples, the training progress processor 128 monitors the progress of a user, such as a driver for example, as the user is executing a training assignment. The training progress processor 128 may monitor the user's progress, current score on any questions and/or activities the user has completed, and any other desired monitoring. Based on the monitoring, the training progress processor 128 may cause the training assignment to be altered, provide a hint, instruct the user to retake a portion of the training already completed before continuing, add additional training directed to one or more topics the user is not yet comprehending, and/or any other action to help the user comprehend the topics of the assigned training being completed. The training progress processor 128 may cause the training assignment processor 127 to perform the above actions and/or the training progress processor 128 may direct the actions. The training progress processor 128 may send the training progress and results to other processors including, for example, the natural language processor 123 and the document analysis processor 124 based on how the training progress and results update driver behavior data. For example, the training progress processor 128 may produce a textual report including the training progress and results and send the report to the natural language processor 123 for processing. In another example, the training progress processor 128 may update and/or create tokenized documents and send the updated documents to the document analysis processor. In further examples, the training progress processor 128 may update and/or create document vectors and/or document fingerprints sent to the training assignment processor 127.

In at least some examples, the server 120 includes a video processor that processes video data including, for example, a video portion of electronic training content and video driver behavior data such as a video portion of a dashboard camera recording. The video processor may process the video data to produce textual data that the natural language processor 123 can process. For example, the video processor may process a video portion of a dashboard camera video. The video may contain video data of a driver operating a vehicle that capture events including, for example, an unsafe turn, speeding, swerving, etc. The video processor can produce textual data that includes the events. The natural language processor 123 can receive textual data for processing.

FIG. 3 illustrates one implementation of a computer system 300 upon which servers, such as server 120 for example, computers, such as computing devices 140, 142, 144 for example, databases, computing devices, or other systems or components described above may be deployed or executed. The computer system 300 may comprise hardware elements that may be electrically coupled via a bus 381. The hardware elements may include one or more Central Processing Units (CPUs) 382; one or more input devices 384 (e.g., a mouse, a keyboard, etc.); and one or more output devices 385 (e.g., a display device, a printer, etc.). The computer system 300 may also include one or more storage devices 387. By way of example, storage device(s) 387 may be disk drives, optical storage devices, solid-state storage devices such as a Random Access Memory (“RAM”) and/or a Read-Only Memory (“ROM”), which can be programmable, flash-updateable and/or the like.

The computer system 300 may additionally include a computer-readable storage media/reader 380; a communications system 379 (e.g., a modem, a network card (wireless or wired), an infra-red communication device, etc.); and working memory 386, which may include RAM and ROM devices as described above. The computer system 300 may also include a processing acceleration unit 383, which can include a Digital Signal Processor (DSP), a special-purpose processor, and/or the like.

The computer-readable storage media/reader 380 can further be connected to a computer-readable storage medium, together (and, optionally, in combination with storage device(s) 387) comprehensively representing remote, local, fixed, and/or removable storage devices plus storage media for temporarily and/or more permanently containing computer-readable information. The communications system 379 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine readable mediums for storing information such as instructions that may executed by the computer system 300.

The computer system 300 may also comprise software elements, shown as being currently located within a working memory 386, including an operating system 388 and/or other code 390. It should be appreciated that alternate implementations of a computer system 300 may have numerous variations from that described above. For example, customized hardware might also be used and/or elements might be implemented in hardware, software (including portable software, such as applets), or both. Further, connection to other computing devices such as network input/output devices may be employed.

Examples of the CPUs 382 as described herein may include, but are not limited to, at least one of Qualcomm® Snapdragon® with 5G, Apple® A12, A13, and M1 processor, Samsung® Exynos® series, the Intel® Core i3®, Core i5®, Core i7® or Core i9® family of processors, the AMD® Ryzen™ family of processors, Texas Instruments® Jacinto C6000® automotive infotainment processors, Texas Instruments® Sitara family of processors, ARM® processors, other industry-equivalent processors, and may perform computational functions using any known or future-developed standard, instruction set, libraries, and/or architecture

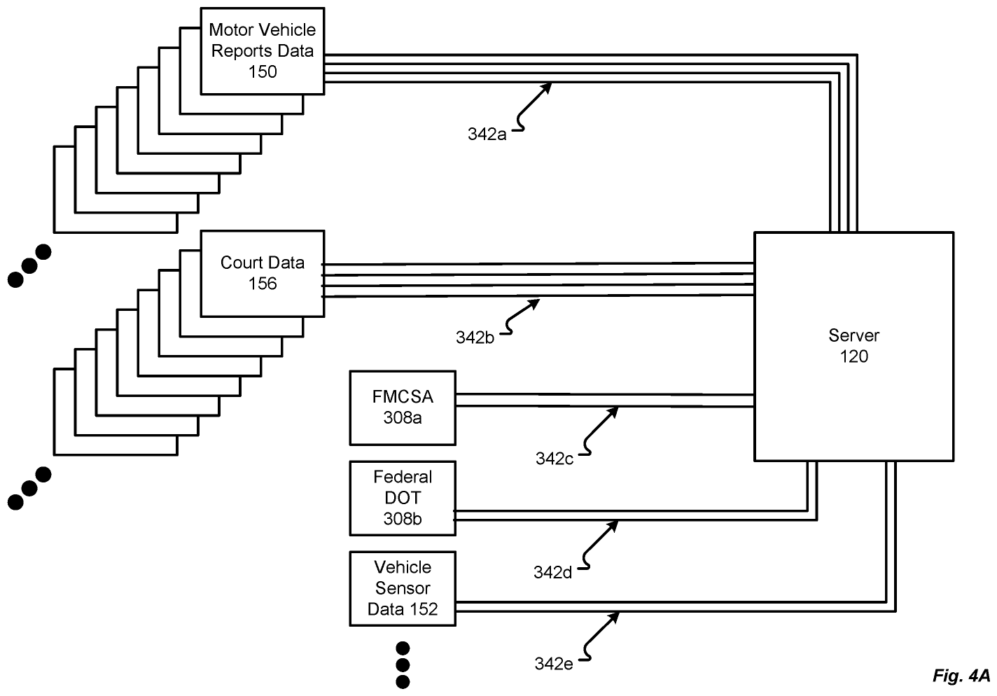

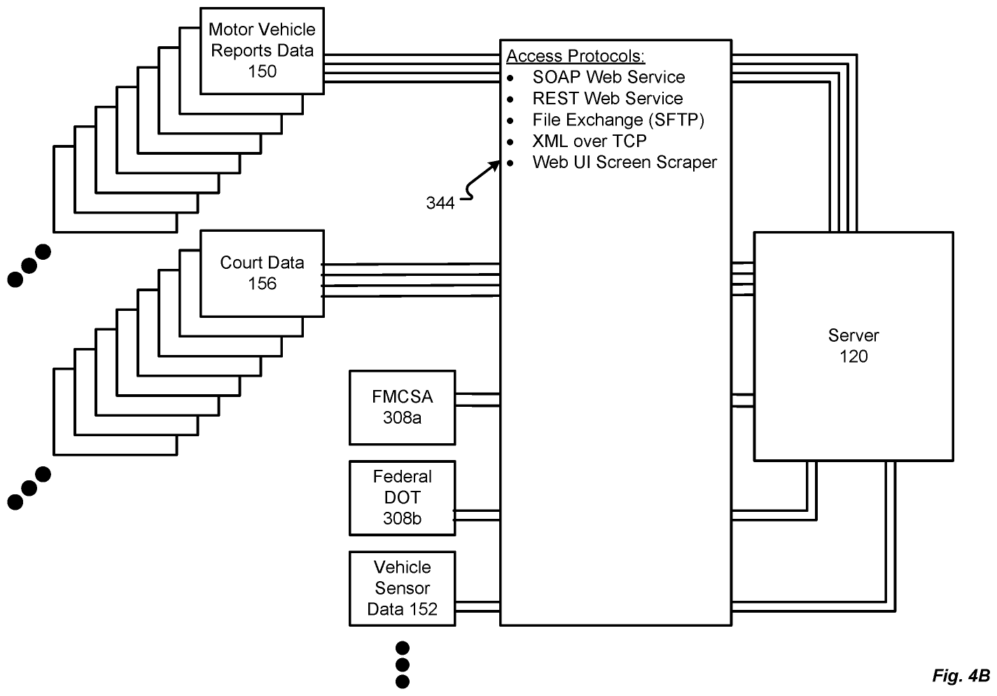

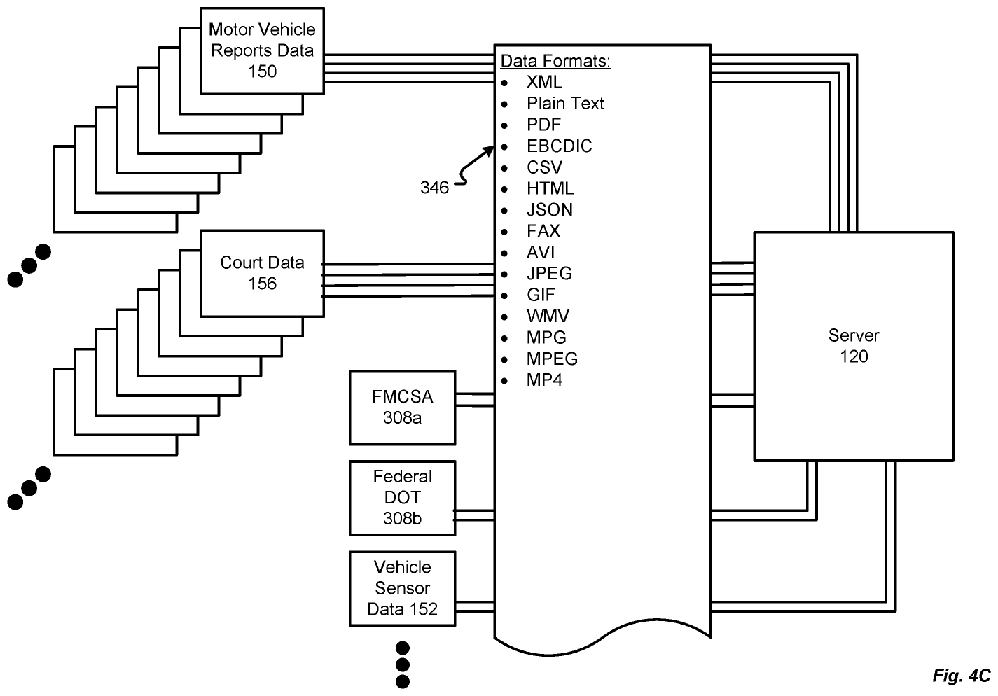

An example implementation of the server 120 receiving information, including, for example, driver behavior data, may be as shown in FIG. 4A. The server 120 may have one or more physical (wired or wireless) or communication system connections between various sources of external data 150, 152, 154, 156, 157, 158, and/or 308. For example, the server 120 may connect to the various sources of external data via the network 110 shown in FIG. 1. As shown in FIG. 3, the server 120 may have communications system connections to Motor Vehicle Reports Data 150, which may include one or more of the States' Licensing Authority (e.g., Department of Motor Vehicles). Each one of these connections may have a different type of connection and/or set of requirements. Further, the server 120 can also have communications system connections to court data 156, which may include one or more States' Courts. The server may also have communications system connections to claims data 154, which may include one or more insurance agencies, other data 158, or other sources of information as shown by ellipses 157 in FIG. 1. The server 120 may have communications system connections to vehicle sensor data 152, which may include connections to one or more vehicles and/or one or more data sources storing vehicle data.

The server 120 may additionally have communications system connections to the Federal Motor Carrier Safety Administration (FMCSA) 308a to obtain Compliance, Safety, Accountability (CSA) information, and/or the Federal Department of Transportation (DOT) systems 308b. Each set of communication system connections 342a-342e may include different types of physical, electrical, communication system, or telecommunication connections.

Some of the connections 342 can include instant MVR connections. These instant MVR connections can allow for the interaction with an Application Programming Interface (API) or other type of interface that allows for the retrieval of MVRs either instantly or in near real-time for one or more drivers. Another type of connection may allow for batch MVR connections. Batch MVR connections can also include an API or interface that allows for the extraction of two or more MVRs for two or more drivers. The connections can also include vehicle record connections that allow for the reading of the MVR without a download or retrieval of such record. Further, one or more connections may be manual motor vehicle record connections that require a form or some other type of interface to be filled out before retrieving MVR. As opposed to the instant or batch MVR connections where a list of names or data may be submitted to the Department of Motor Vehicle (DMV) to retrieve records, the manual connection may require more involved interface interaction that includes entering information to retrieve the MVR.

One or more of the connections may be Virtual Private Network (VPN) connections requiring the establishment of a VPN or security protocols to allow the connection through the VPN. Other connections can include point-to-point connections requiring a more involved interaction to establish a connection between the server 120 and the particular DMV site or system including Motor Vehicle Reports Data 150.

Other connections can include the DOT connections 342d, the FMCSA connection 342c, hosted database connections (which require the retrieval or download of database changes in the DMV database), or other third party vendor connections. The server 120 and/or another system can establish and manage the numerous and varied types of connections to these different systems 150 through 158 and 308 to retrieve data. In this way, the server 120 provides a technical advantage in allowing for the retrieval and processing of large volumes of electronic data over disparate and different electronic data connections for retrieval of MVR data that would not be able to be retrieved manually by a person and certainly not by a person in a timely manner.

In examples, the data is received or otherwise accessed by the server 120 when a new driver is added to the system. For example, the driver may be a new employee, starting a driving role, or added to the system for another reason. The server 120 may receive data including, for example, driver behavior data related to the new driver from the external data sources. The server 120 may additionally receive data from the external data sources periodically. For example, the server 120 may receive data for one or more desired drivers each week to ensure that the data related to each driver is up to date. In other examples, the server 120 may monitor the external data sources to receive updated and/or new data related to one or more desired drivers as the data becomes available.

In examples, the data received by the server 120 can be sent to operator database 130 and/or training content database 132 shown in FIG. 1. the operator database 130 and/or training content database 132 may store the data for access by the server 120. The server 120 may send the data via network 110 and/or some other connection. The data may be processed before and/or after being sent to the operator database 130 and/or training content database 132. In additional examples, the operator database 130 and/or training content database 132 may receive the data directly from the external data sources 150 through 158 and 308 to retrieve data. The operator database 130 and/or training content database 132 may have the same or similar connections to the external data sources as described above with respect to the server 120.

Another example implementation of the server 120 receiving information, such as driver behavior data for example, may be as shown in FIG. 4B. The server 120 may employ one or more access protocols to retrieve data from the external data sources 150, 152, 154, 156, 157, 158, and 308. For example, the server 120 may use a Simple Object Access Protocol (SOAP) web service to retrieve data. SOAP is a messaging protocol that allows the exchange of structured information in the web service. SOAP can use an eXtensible Markup Language (XML) information set for message format and can rely on Hypertext Transfer Protocol ((HTTP) for messaging transmission. SOAP allows for the invocation of processes on the operating systems to communicate by XML.

In another example, the server 120 may employ the REpresentational State Transfer (REST) web service. REST is an architectural style that can provide interoperability between computers systems on the Internet. REST allows for the manipulation of textual representations on the Internet using stateless operations. REST allows for the request of information to a data source Uniform Resource Indicator (URI) that may be responded with a type of payload, for example, HyperText Markup Language (HTML), XML, JavaScript Object Notation (JSON), or another format. The responses can indicate a change to a resource state and allow for the request of that information.

Other protocols can include the Secure SHell Protocol (SSH) File Transfer Protocol also referred to as the Secure File Transfer Protocol (SFTP) that provides file access, file transfer, and file management over a data stream. SFTP allows for a secure channel to be created between the server 120 and the external data source for file transfer over the Transport Layer Security (TLS) layer and transfer of management information in a VPN. SFTP allows for a wide variety of operations to be made on a remote file, including extracting data therefrom to be provided to the server 120.

The server 120 may also retrieve XML over Transmission Control Protocol (TCP). TCP allows the delivery of bytes of data in an XML file from the external data source to the server 120. This TCP protocol allows for file transport of the XML data over the TCP connection.

In some very rudimentary DMV systems, the server 120 can also use a screen scraper to scrape the web-based User Interface (UI) of the external data source. In this implementation, the server 120 reads or retrieves data presented in a UI at the DMV user interface or web window. The server 120 can extract this information and any metadata that may be available by the look and feel of the user interface and compile MVRs from such screen-captured information.

In examples, the operator database 130 and/or training content database 132 may receive the data directly from the external data sources 150 through 158 and 308 to retrieve data. The operator database 130 and/or training content database 132 may receive the data using the same or similar access protocols for the external data sources as described above with respect to the server 120.

Beyond the protocols used to obtain the data from the external data sources, the server 120 can also ingest or retrieve various data formats. The various data formants may be as shown in FIG. 4C. The data formats 346 can include one or more of, but are not limited to, XML, plaintext, Extended Binary Coded Decimal Interchange Code (EBCDIC), Comma Separated Values (CSV), HTML, JSON, fax data, Portable Document Format (PDF), Audio/Video Interleaved (AVI), Graphics Interchange Format (GIF), Windows Media Video (WMV), Multiple Protocol Gateway (MPG), Moving Picture Experts Group (MPEG), MPEG-4 Part 14 (MP4), etc. XML is a markup language that includes a set of rules for encoding documents in a format that's both human readable and machine readable. XML's schema specification may be as provided by the World Wide Web Consortium. Various different XML schemas have been developed, and the server 120 may include one or more APIs used to process the XML data from the external data sources 108-116 depending on the schema used by said external data source.

EBCDIC is a byte character encoded file format mainly used on mainframes systems. EBCDIC was developed by IBM® to communicate data amongst mainframe or other types of computing systems. The server 120 can process the EBCDIC files.

CSV is a text file format that uses commas to separate data values. Each record within a CSV file may have one or more fields that are separated by commas. A CSV file may not be standardized, and as such, the server 120 can include an API or other type of interface to extract data that is particular to those CSV file formats of the data source.

HTML is another markup language that is designed for display in web browsers. An HTML document may be retrieved by a Web server and rendered into a webpage. The server 120 can extract HTML elements and/or one or more items of metadata, if available, to create documents from the provided HTML.

JSON is an open standard file format that can use human readable text to store and transmit data objects. JSON can consist of attribute value pairs and an array of data types. JSON can serve as a replacement for XML. The server 120 can parse the JSON formatted data and retrieve such data for provision to other functions.

Another possible data form is a Portable Document Format (PDF). PDF is a file format developed by Adobe® to present documents that is system independent. PDFs may include an image or actual text. If an image is provided in the PDF, an optical character recognition function may transform the image into readable text.

In still other implementations, an image may be provided from an image capture device, e.g., a camera. A vehicle monitor or control system can produce images of traffic incidents, e.g., crashes. The images may be analyzed to determine information about a driving event, for example, who was at fault for the incident. These images may be imported with or without metadata to determine driver profile information.

In some implementations, the data from the DMV may be received as fax. This telephonic transmission of scanned data may be received by the server 120 and interpreted into an image. The image may then be scanned for characters or other information using optical character recognition or other types of transformations. The output of the text recognition system may then be provided to other functions by the server 120.

There may be other types of data formats used and ingested by the server 120. Further, the server 120 can access data using different types of protocols or different types of connections than those described herein. Thus, the server 120 is operable to retrieve data using numerous types of data connections, file formats, and protocols and outputting all the data from these different systems into one or more of the processors 121, 122, 123, 124, 125, 126, 127, 128 shown in FIG. 2.

In examples, the data received by the server 120 can be sent, in any of the formats described above, to operator database 130 and/or training content database 132 shown in FIG. 1. the operator database 130 and/or training content database 132 may store the data for access by the server 120. The server 120 may send the data via network 110 and/or some other connection. The data may be processed before and/or after being sent to the operator database 130 and/or training content database 132, including converting the format of the data. In additional examples, the operator database 130 and/or training content database 132 may receive the data directly from the external data sources 150 through 158 and 308 to retrieve data. The operator database 130 and/or training content database 132 may receive data in any of the formats as described above with respect to the server 120.

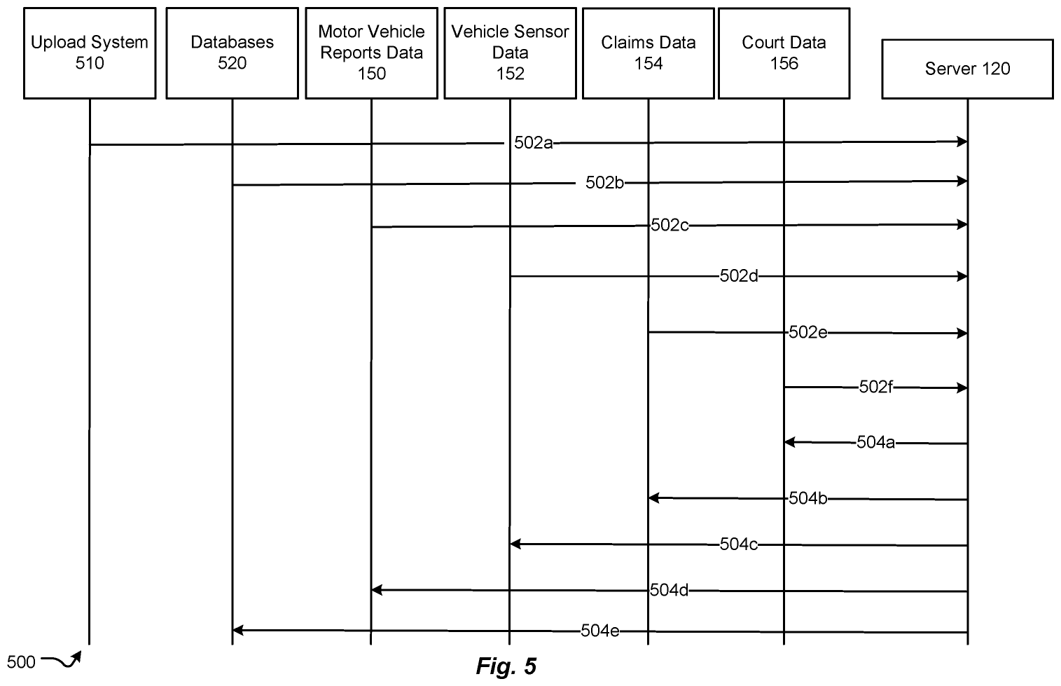

FIG. 5 depicts an example signaling process for the server 120 to receive data from external data sources. The signaling process may be between upload system 510, external data sources 150, 152, 154, 156, and/or the server 120. In at least some configurations, a user may send an upload of driver information, in signal 502a, from a user upload system 510. The user may use a computing device 140, 142, 144 to access the upload system 510. The upload information can include or add drivers to a customer roster of drivers that should be evaluated and monitored by the server 120 to assign training based on driver behavior data. The upload information can also include driver behavior data that the user wishes to upload to the system including, for example, claims data, motor vehicle reports data, court data, or the like.

The server may access databases 520, including, for example, the operator database 130 and/or the training content database 132. The databases 520 may send data using signal 502b. The server 120 may retrieve or request data from the databases 520 using signal 504e. Further, if a user uploads data using upload system 510, the server 120 can send the data to the databases 520 using signal 504e.

The server may also access one or more third party data integrations, represented by external data sources 150, 152, 154, 156, in one or more signals 502c, 502d, 502e, and/or 502f. The server 120 can retrieve or request information from the external data sources 150, 152, 154, 156 through signals 504a-d. This information may be returned to the server 120 in signals 502c through 502f. The server 120 can store the data into one or more of the databases 130, 132. Further, if a user uploads data using upload system 510, the server 120 can send the data to the external data sources 150, 152, 154, 156 using signals 504a-d.

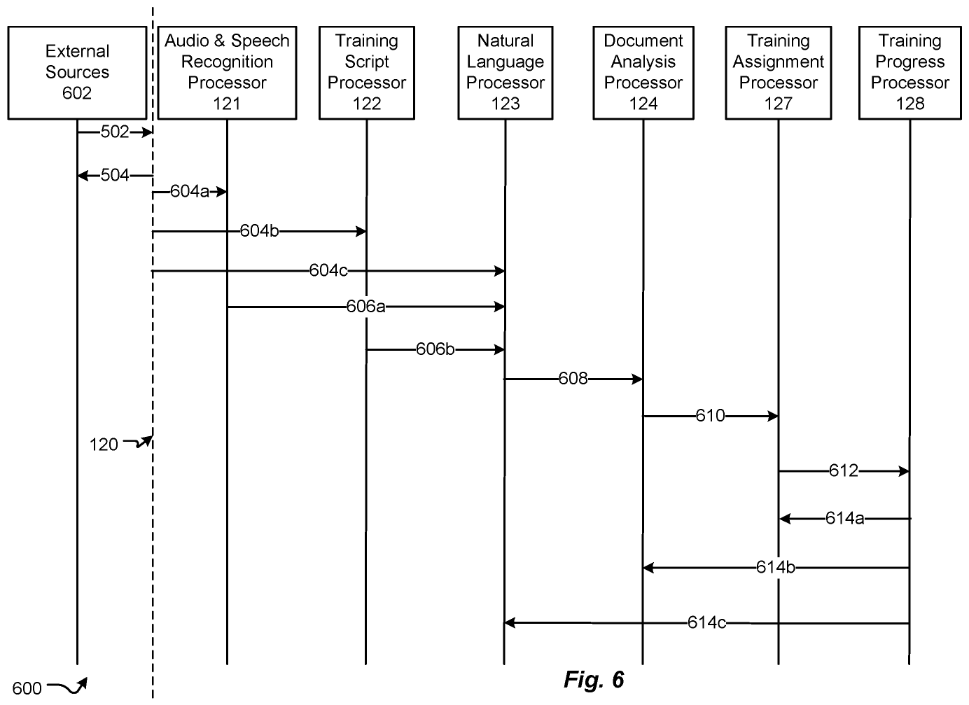

FIG. 6 depicts an example signaling process for the processors of the server 120 to receive and/or process data. The signaling process may be between the external sources 602, which may include upload system 510, external data sources 150, 152, 154, 156, 157, 158, operator database 130, and/or training content database 132, the server 120, audio & speech recognition processor 121, training script processor 122, natural language processor 123, document analysis processor 124, training assignment processor 127, and/or training progress processor 128. The server 120 may receive data from external data sources via signal 502, shown in FIG. 5. The server 120 may also retrieve or request data via signal 504, shown in FIG. 5.

The data received via signals 502 and/or 504 may be received by one or more of the audio & speech recognition processor 121, the training script processor 122, and the natural language processor 123, via signals 604a, 604b, and 604c respectively. The audio & speech recognition processor 121 receives data via signal 604a that has an audio component that needs to be processed before being sent to the natural language processor. The training script processor 122 receives data via signal 604b that includes one or more scripts that need to be processed before being sent to the natural language processor 123. The natural language processor 123 receives data that is ready for natural language processing via signal 604c. In examples, portions of data are processed by the audio & speech recognition processor 121, training script processor 122, and natural language processor 123 simultaneously or substantially simultaneously. For example, an audio portion of an electronic training content document may be processed by the audio & speech recognition processor 121, a script portion of the electronic training document is processed by the training script processor 122, and another portion of the electronic training document is processed by the natural language processor 123 simultaneously.

The audio & speech recognition processor 121 can send processed audio data to the natural language processor 123, via signal 606a. The training script processor 122 can send processed script data to the natural language via signal 606b.

The natural language processor 123 sends tokenized data to the document analysis processor 124, via signal 610. As explained above, tokenized data is data that is processed by the natural language processor 123 by creating tokens in the documents, processed using algorithms, such as TF-IDF for example, to assign values to tokens that indicate the relevance of the token in the document, and/or other processed through other operations to prepare the documents to be compared by the training assignment processor 127.

The document analysis processor 124 sends document vectors, document fingerprints, and/or data processed in other ways that are prepared for comparison to the training assignment processor 127, via signal 610. As explained above, the document analysis processor 124 processes the tokenized data received from the natural language processor 123 to prepare the documents for comparison, including, for example, creating ranks for documents, creating document vectors, and/or creating document fingerprints.

The training assignment processor 127 sends assigned training and/or a notification of assigned training to training progress processor 128, via signal 612. As explained above, the training assignment processor compares driver behavior data and electronic training content using the document vectors, document fingerprints, and/or data processed in other ways by the document analysis processor 124 that are ready for comparison to identify and assign relevant training for one or more drivers.

The training progress processor 128 sends training progress including, for example, assignment progress and training results to the natural language processor 123, document analysis processor 124, and/or the training assignment processor 127, via signals 614a, 614b, and 614c respectively.

In some examples, the processors of the server 120, including 121, 122, 123, 124, 127, 128, may retrieve or request data from the other processors of the server, via signals not shown in FIG. 6.

An example of a data store 700, which may represent one or more items of the data stored in various data stores and/or external data sources such as 130, 132, 150, 152, 154, 156, 157, 158, 308, 387, 602, etc. may be as shown in FIGS. 7A, 7B, and 7C. The data store 700 can include one or more data structures 704, 728, and/or 750. There may be more or fewer data structures, in data store 700, than those shown in FIGS. 7A, 7B, and 7C. In some examples, the data structures 704, 728, and/or 750 are stored by the server 120.

Data structure 704 may represent driver information. The data structure 704 can include one or more of, but is not limited to, driver's license information or number 708, a driver IDentifier (ID) 710, state information 712, biographical information 716, etc. There may be more or fewer fields in data structure 704, as represented by ellipses 720. Further, each driver may have their own data structure 704, and thus, there may be more data structures 704 shown in data store 700, as represented by ellipses 724.

Driver's license information 708 can include the driver's license number(s) from the driver's license(s) of the driver. The driver's license information 708 can also include other information, for example, an address, a height, a weight, eye color, hair color, whether the driver desires to be an organ donor, etc. This information may be used to identify the driver and may be used to help record or retrieve information about the driver from various external data sources.

The driver ID 710 can be a separate identifier for a driver. The ID can be a numeric ID, an alphanumeric ID, a name, a Globally Unique IDentifier (GUID), or some other type of ID. Regardless of the type of ID 710, the driver ID 710 can uniquely identify the driver amongst other drivers in the organization or within the safety system 104.

State information 712 can include the state where the driver's license 708 was issued, the state of residence, or other state information. The state information 712 describes the jurisdiction for the driver and may change the driver policy based on this information.

The biographical information 716 can be any information about the driver that may be provided by the driver's license 708 or other sources. As such, the biographical information 716 can include the name, address, phone number, or other information. This information 716 may be used to better identify the driver.

Data structure 728 can include information regarding the driver's performance. The data structure 728 can include one or more of, but is not limited to, a driver ID 710, data source 732, driver behavior data 734, processed driver behavior data 736, assigned training 737, and/or training results 738. There may be more or fewer data fields in data structure 728, as represented by ellipses 740. Each driver may have a different data structure 728 and, as such, there may be more or fewer data structures 728 in data store 700, as represented by ellipses 744.

The driver ID 710 may be the same or similar to the driver ID 710, as described in conjunction with data structure 704. As such, the driver ID 710 will not be explained further herein.

The data source 732 can be an indication or pointer to the external data source from which the information contained in the data structure 728 originated. The data structure source 732 can include an identifier for that external data source, whether the identifier is a URI or another type of ID. Data source 732 may also include an identifier to the data used to generate assigned training. Thus, data source 732 can include identifiers to infractions, collisions, or other data that may have generated the assigned training.

The driver behavior data 734 is any of the driver behavior data associated with the driver. The driver behavior data may be received by the external data sources and stored at driver behavior data 734. The driver behavior data can include motor vehicle reports data, vehicle sensor data, court data, claims data, and any other data related to driver behavior.

The processed driver behavior data 736 is driver behavior data from driver behavior data 734 that may be processed by the processors of the server 120. The processed driver behavior data may include tokenized driver behavior data, driver behavior data topics that has been assigned ranks, driver behavior data vectors, and/or driver behavior data fingerprints.

Assigned training 737 is the training that has been assigned to the driver. The training assignment processor 127 may assign the training and cause the assigned training to be stored in assigned training 737.

Training results 738 is the completed training and the results of the completed training. The training progress processor 128 may monitor the completion of the training and cause the training results to be stored in the training results 738.

Data structure 750 can include information regarding the electronic training content. The data structure 750 can include one or more of, but is not limited to, an electronic training content ID 752, electronic training content 752, processed audio & speech 754, processed scripts 756, and/or processed training content 758. There may be more or fewer data fields in data structure 750, as represented by ellipses 760. Each electronic training content document may have a different data structure 750 and, as such, there may be more or fewer data structures 750 in data store 700, as represented by ellipses 762.

The electronic training content ID 752 can be a separate identifier for electronic training content. The ID can be a numeric ID, an alphanumeric ID, a name, a globally unique identifier (GUID), or some other type of ID. Regardless of the type of ID 752, the electronic training content ID 752 can uniquely identify the electronic training content amongst other electronic training content in the training content database 132 or within the environment 100.

The electronic training content 753 can be the contents of the electronic training content. The electronic training content 753 may alternatively be an indication or pointer to the data source that stores the electronic training content. For example, the electronic training content may be stored in the training content database 132, and the electronic training content 753 includes a pointer to the place the electronic training content is stored in the training content database 132.

The processed audio & speech 754 can be the data produced after processing any speech and/or audio content of the electronic training content and/or a pointer or indicator to the location of the processed audio and/or speech data. For example, the audio & speech recognition processor 121 may process the speech and/or audio content of the electronic training content and cause the processed data and/or the pointer to be stored in processed audio & speech 754. In examples, the processed data is textual data of the speech and/or audio. The natural language processor 123 may access processed audio & speech 754 to perform natural language processing.

The processed scripts 756 can be the processed script data of the electronic training content and/or a pointer or indicator to the location of the processed scripts. For example, the training script processor 122 may process the scripts of the electronic training content cause the processed data and/or the pointer to be stored in processed scripts 756.

The processed training content 758 is electronic training content from electronic training content 753 that may be processed by the processors of the server 120. The processed electronic training content may include tokenized electronic training content, electronic training content that has been assigned ranks, electronic training content vectors, and/or electronic training content fingerprints.

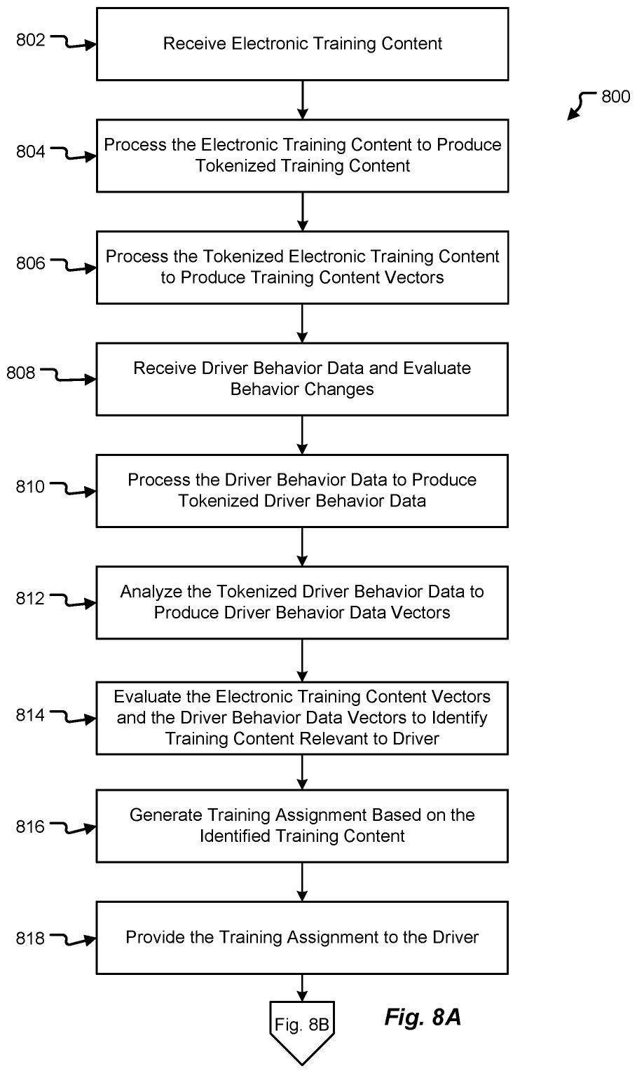

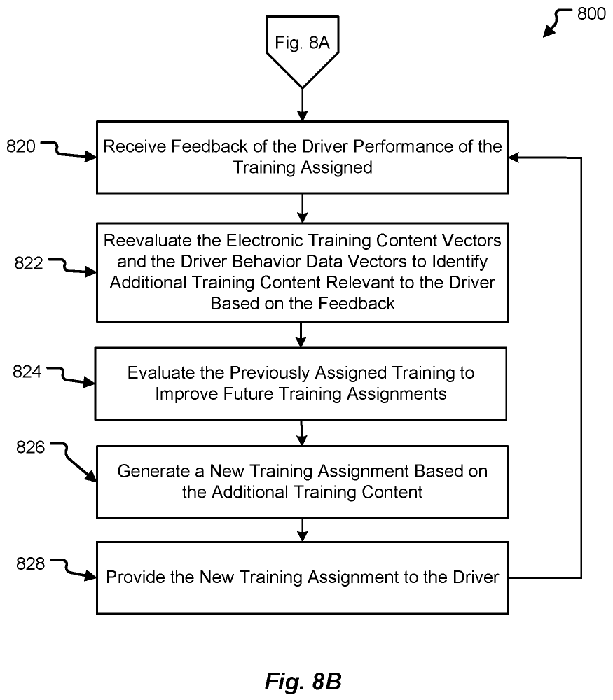

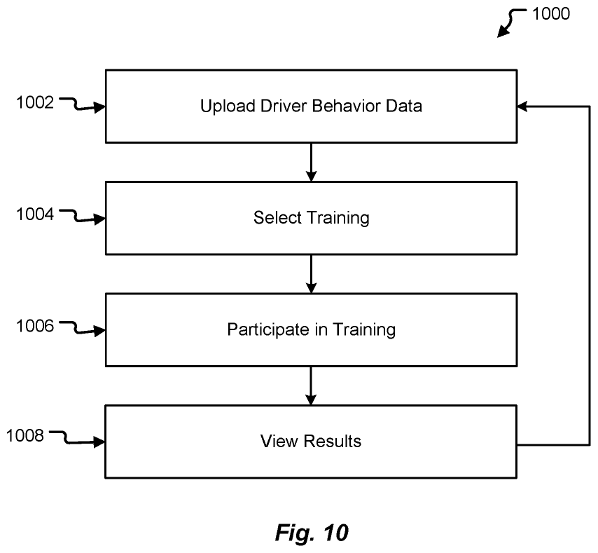

FIGS. 8A, 8B, and 10 depict example methods associated with assigning training to a user and/or completing the training. The methods may include more or fewer operations in other examples, and the operations depicted may be performed in a different order in further examples. The methods 800 and 1000 can be executed as a set of computer-executable instructions, executed by a computer system or processing component, and be encoded or stored on a storage medium or memory. Further, the methods 800 and 1000 can be executed by a gate or other hardware device or component in an Application Specific Integrated Circuit (ASIC), a Field Programmable Gate Array (FPGA), a System-On-Chip (SOC), or other type of hardware device. Hereinafter, the methods 800 and 1000 shall be explained with reference to the systems, components, modules, software, data structures, user interfaces, etc. described herein.

FIG. 8A depicts an example method 800 associated with assigning training based on behavior data. Method 800 begins at stage 802 where electronic training content is received. For example, the server 120 receives or otherwise accesses electronic training content stored in training content database 132. The server 120 may access any number of electronic training content documents.

Proceeding to stage 804, the electronic training content is processed to produce tokenized electronic training content. Electronic training content can include one or more of, but is not limited to, audio, textual, and/or video content, and/or metadata about the content. For example, the audio & speech recognition processor 121 processes audio portions of the electronic training content and sends the processed audio data to the natural language processor 123, the training script processor 122 processes script or textual portions of the electronic training content and sends the processed script data to the natural language processor 123, and the natural language processor process the electronic training content to produce tokenized electronic training content. In at least one configuration, the training script processor 122 uses a technique called Bidirectional Encoder Representations from Transformers (BERT) to complete training content textual generalization and keyword extraction. One or more electronic training content documents may be processed at the same time by the audio & speech recognition processor 121, the training script processor 122, and/or the natural language processor 123.

A large amount of electronic training content may be received by the server 120 at the same or substantially the same time in stage 802. For example, the server 120 may receive two terabytes (TB) of electronic training content at once. The two TB of electronic training content may be tokenized in stage 804 quickly at the same time or concurrently, such that the data is tokenized faster than would be possible by conventional means, for example, by human evaluation. A token can be a predetermined class of training, e.g., speeding, braking, aggressive driving, etc. The output of the tokenization is a set of metadata associated with each item of training content that describes what the training addresses, the problems the training attempts to fix, the most important or frequently used words in the training, etc. Each token is filtered to consolidate like tokens, e.g., words with a same meaning are consolidated under a single token, which may be the predetermined class of tokens. The output is a set of words (e.g., tokens) or word clusters and/or string values (e.g., a number or instances of the words occur in the content) that describe the training.

Once the tokenized electronic training data is produced, the tokenized electronic training data is processed to produce electronic training content vectors. For example, the document analysis processor 124 receives the tokenized electronic training content from the natural language processor 123 and processes the tokenized electronic training content to produce electronic training content vectors. A electronic training content vector is a representation of how indicative the token is of describing the training content. In a configuration, the electronic training content vector can be a number of instances a token occurs in the training. The document analysis processor 124 may produce the electronic training content vectors using the methods described above. In some examples, the document analysis processor may produce electronic training content fingerprints and/or other processed data that is prepared for comparison instead of or in addition to producing the electronic training content vectors. The electronic training content fingerprint can be the set of electronic training content vectors that characterize the training content.

In the example where a large amount of electronic training content is received, the tokenized electronic training content may be processed in stage 806 quickly at the same time or concurrently, such that the data is processed and vectors are created faster than would be possible by conventional means, for example, by human evaluation.

In some examples, electronic training content is updated or added at different times. Operations 802, 804, and 806 can occur at any time content is updated or added to ensure that the most relevant or otherwise useful training is assigned to drivers. Further, the operations 802, 804, 806 can reoccur if feedback determines that the training content did not change outcomes for drivers and thus the electronic training content vectors may not be associated to the driver behaviors due to misclassification of the tokens or incorrect electronic training content fingerprints.

In stage 808, driver behavior data is received and behavior changes are evaluated. For example, the server 120 receives or otherwise accesses driver behavior data stored in operator database 133, external data sources 150, 152, 154, 156, 157, 158, and/or data sent via computing devices 140, 142, 144. The server 120 may access any number of driver behavior data documents. The driver behavior data may be received in response to a new driver being added to the system, driver behavior data being changed, and/or some other even that triggers the electronic training content to be received. For example, a driver may have recently been involved in a traffic accident, causing the driver behavior data associated with the driver to be updated and causing the server 120 to receive the updated driver behavior data. A large amount of driver training data may be received at the same time in stage 808. For example, driver behavior data associated with thousands of drivers may be received at the same time or substantially the same time. The drivers may be associated with a large entity and/or associated with multiple entities, and all of the drivers may need some type of training. In some examples, only driver behavior data associated with drivers that need training will be received. In other examples, all driver behavior data will be received, and the server 120 may only proceed with method 800 with driver behavior data that indicates the associated driver requires training. In still other examples, the server 120 may receive or retrieve only data that has changed for one or more drivers, where the changed data indicates that the driver may require training. The amount of data that is processed and number of data sources accessed to determine the need for driver training would not be possible by conventional means, for example, by human evaluation. Further, the speed at which the data is retrieved and the need for driver training is determined also would not be possible by conventional means, for example, by human evaluation.

Driver behavior data continues to change based on the driving performance of the driver. Therefore, updated driver behavior data may be received in stage 808 at any time. The server 120 may evaluate how the driver behavior data changes for driver behavior that is updated. The evaluation may allow the server 120 to change how training content and/or driver behavior data is evaluated how electronic training content is assigned including, for example, in stages 814, 816, 818, 820, 822, 824, 826, and 828 described below. For example, the driver may have completed training related to speeding, but the driver behavior data is updated to indicate that the driver is still having negative driver behaviors related to speeding. The server 120 may evaluate the effectiveness of the previously assigned training assignment related to speeding, the performance of the driver when completing the training, or the like to determine why the driver behavior was not corrected as intended with the previously assigned training. The server 120 can alter how training is assigned, alter electronic training content, or the like to lower instances of drivers completing training related to a driver behavior and still exhibiting the driver behavior. For example, electronic training content that is completed and results in drivers still exhibiting the behavior may be used less or not at all, and electronic training content that is completed and results in drivers no longer exhibiting the behavior may be assigned more often to other drivers exhibiting the behavior as indicated by the associated driver behavior data. Further, the model that determines how the training is assigned may be modified and improved to ensure the training that is determined as needed causes changes in driver behavior.

Proceeding to stage 810, the driver behavior data is processed to produce tokenized driver behavior data. For example, the audio & speech recognition processor 121 processes any audio portions of the driver behavior data and sends the processed audio data to the natural language processor 123, the training script processor 122 processes any script portions of the driver behavior data and sends the processed script data to the natural language processor 123, and the natural language processor process the driver behavior data to produce tokenized driver behavior data. One or more driver behavior data documents may be processed at the same time by the audio & speech recognition processor 121, the training script processor 122, and/or the natural language processor 123. The driver behavior can be classified similarly to the training content in that words associated with the behavior are determined and then a number of instances or an importance of those words become vectors associated with the driver. In the example where a large amount of driver behavior data is received at the same time in stage 808, the driver behavior data may be tokenized in stage 810 quickly at the same time or concurrently, such that the data is tokenized faster than would be possible by conventional means, for example, by human evaluation.

Once the tokenized electronic training data is produced, the tokenized electronic training data is processed to produce driver behavior data vectors. For example, the document analysis processor 124 receives the tokenized driver behavior data from the natural language processor 123 and processes the tokenized driver behavior data to produce driver behavior data vectors. The document analysis processor 124 may produce the driver behavior data vectors using the methods described above. In some examples, the document analysis processor 124 may produce driver behavior data fingerprints and/or other processed data that is prepared for comparison instead of or in addition to producing the driver behavior data vectors. Additionally, the document analysis processor 124 may use the tokenized driver behavior that is associated with a driver to create one or more driver behavior data vectors. For example, the document analysis processor 124 may create cohort of similar drivers having essentially a similar driver behavior data vector using each tokenized driver behavior data document, including, for example, a vehicle sensor data document indicating speeding, a court document directed to failure to stop at a stop sign, and a claim document directed to an accident the driver was involved in. In the example where a large amount of driver behavior data is received at the same time in stage 808, the tokenized driver behavior may be processed in stage 806 quickly at the same time or concurrently, such that the data is processed and vectors are created faster than would be possible by conventional means, for example, by human evaluation.

In some examples, driver behavior data is updated or added at different times. Operations 808, 810, and 812 can occur at any time driver behavior data is updated or added to ensure that the most relevant or otherwise useful training is assigned to each driver. In some instances, the operations 808, 810, and 812 are repeated periodically to determine if driver behavior improved after training or if other or further training is needed.

Once the electronic training content vectors and the driver behavior data vectors are produced, flow proceeds to stage 814. In stage 814, the training assignment processor 127 evaluates the electronic training content vectors and the driver behavior data vectors to identify training content relevant to a driver. For example, the training assignment processor 127 evaluates and correlates the electronic training content vectors and the driver behavior data vectors, via methods and the equation described above with respect to FIG. 2 for example. In a configuration, a matrix associates the electronic training content vectors (e.g., a training classifier or multiple training classifiers, for example, reckless driving training) and the driver behavior data vectors (e.g., the driver behavior classifier or multiple behavior classifiers, for example, reckless driving). Drivers with similar profiles are placed in similar cohorts. The cohorts are then correlated with training content. A driver may receive one or more trainings based on their cohort. Further, the driver's cohort may change over time based on changed driver behavior data vectors. The training assignment processor 217 may use the equation(s), algorithm(s), process(es) described above to determine the distance between the electronic training content vectors and the driver behavior data vectors. The smaller the distance between the electronic training content vectors and the driver behavior data vector, the more likely the electronic training content is to be relevant to the driver.

In a configuration, the training assignment processor 127 determines a similarity between text strings, the electronic training content vectors, and/or the driver behavior data vectors. In addition to comparing numeric data vectors, string based methods can also compare the textual input data as described herein to find similar text strings. The similarity may be a matrix measurement comprised of two or more separate comparisons and/or measurements. The separate measurements and/or comparisons can include one or more of, but is not limited to, Soundex, Ngram, Jaccard Similarity, Sequence Matching, and/or Levenshtein distance. Soundex is a phonetic algorithm for indexing names by sound, as pronounced in English. With Soundex, homophones are encoded to the same representation for matching despite minor differences in spelling. N-gram is a contiguous sequence of n items from a given sample of text or speech. N-gram models are widely used in statistical natural language processing and to determine similarities in words. The Jaccard similarity coefficient (Jaccard Similarity), is a statistic used for gauging the similarity and diversity of sample sets. Sequence matching is the act of checking a given sequence of tokens for the presence of the constituents of some pattern. The patterns generally have the form of either sequences or tree structures. Uses of sequence matching include outputting the locations (if any) of a pattern within a token sequence, to output some component of the matched pattern, and to substitute the matching pattern with some other token sequence (i.e., search and replace). Finally, Levenshtein distance is a string metric for measuring the difference between two sequences. Informally, the Levenshtein distance between two words is the minimum number of single-character edits (insertions, deletions or substitutions) required to change one word into the other. These measurements may be used in combination to determine how much similarity there is between the vectors of the training and the driver's behavior. One or more of the outputs of the algorithms above may be weighted depending on the desired outcome or on previous use.

The training assignment processor 217 may assign weights to the vectors or types of outputs above to focus on a particular driving behavior. For example, if a driver behavior vector includes a speeding dimension with a high value, the training assignment processor may determine that training related to speeding must be assigned to the driver. The training assignment processor may weight the other dimensions of the vectors to focus on training related to speeding.

In some examples, the server 120 determines that one or more drivers do not need training. For example, the server 120 may determine that a driver does not need training by evaluating the driver behavior data vector associated with the driver. The value of each dimension of the driver behavior data vector may be below a threshold that indicates that the driver does not need training in the area associated with each dimension. In this case, the server 120 may not compare the driver behavior data vector with electronic training content vectors because the driver does not need training. In another example, the server 120 only receives driver behavior data in stage 808, so each driver behavior data vector will be evaluated with electronic training content vectors.

The training assignment processor 127 may evaluate electronic training content vectors and driver behavior data vectors for one or more drivers to identify training for multiple drivers at once. For example, the training assignment processor 127 may evaluate electronic training content vectors with thousands of driver behavior data vectors quickly and at the same time or substantially the same time to allow drivers to be assigned training faster than would be possible by conventional means. The server 120 may also store and/or cause another system to store the electronic training content vectors and/or driver behavior data vectors in an order that allows the server 120 to compare potentially relevant electronic training content vectors to the driver behavior data vectors so that not every electronic training content vector needs to be compared to each driver behavior data vector. For example, the storage of the vectors may be structured so that vectors with similar dimensions are stored such that the server 120 knows which dimensions the vectors have and can access the desired vectors quickly. This storage system may allow the server 120 to compare the vectors more quickly, especially compared to conventional means including by human evaluation for example.

In stage 816, a training assignment is generated based on the training content identified in stage 814. For example, the training assignment processor 127 generates one or more training assignments for one or more drivers based on the identified training content. The identified training content is one or more electronic training content documents. Typically, the training assignment includes at least one of the identified electronic training content items. Each training assignment that is generated may include one or more electronic training content documents. The training assignment can include video that the driver is assigned to watch, audio the driver is assigned to listen to, textual data the driver is assigned to read, questions the driver is assigned to answer, and/or other training formats that are included in the electronic training content that is identified in stage 814.

In stage 818, the training assignment that is generated in stage 816 is provided to the driver. The training assignment can include one or more electronic training content documents. The electronic training content documents may be related to the same driver behavior and/or different driver behaviors. For example, the training assignment processor 127 causes the assigned training for each of the one or more drivers to be sent to a computing device 140, 142, 144 that are associated with driver that is assigned the training. In another example, the training assignment processor 127 causes the training to be assigned via a training interface, including the interface shown in FIG. 9 for example, that can be accessed by the driver assigned the training. The server 120 can host or otherwise provide the training, including presenting video, audio, text, questions, and other types of training formats. The server 120 can also alter the training content being provided based, for example, on the progress and results feedback monitored by the training progress processor 128 including, for example, by removing, adding, or otherwise altering electronic training content being provided.

Method 800 continues in FIG. 8B beginning with stage 820. In stage 820, feedback of the driver performance of the assigned training is received. For example, the training progress processor 128 monitors the progress and results of the training assignment. The training assignment can send the training progress and results to one of the other processors of server 120 to update the driver behavior data or otherwise change the driver information. For example, the training assignment processor 127 receives the progress and results of a driver and updates the driver behavior vector(s) of the driver based on the progress and results. For example, the driver may have failed a training based on speeding. The training assignment processor 127 may update the driver behavior data vector(s) and/or create a new driver behavior data vector of the driver to indicate that further training directed to speeding is required,

In stage 822, the electronic training content vectors and the driver behavior data vectors are reevaluated to identify additional training content relevant to the driver based on the feedback. For example, the training assignment processor 127 may update the driver behavior data vector(s) and/or create a new driver behavior data vector of the driver based on the feedback of the training results and progress. This allows the training assignment processor 127 to reevaluate the driver behavior data vectors with the electronic training content to identify additional training content that the driver needs to take and not assign training that the driver has comprehended and no longer needs training on.

In stage 824, the previously assigned training is evaluated, by the server 120 for example, to improve future training assignments. Because the driver failed the assigned training, the training assignment and the driver results may be evaluated to improve future training assignments. For example, the server 120 may determine that the previously assigned training is not applicable to the driver behavior that the training was assigned for, the assigned training is insufficient or otherwise improper for teaching the driver to correct the driver behavior, the driver does not understand the training, or the like. The server 120 may alter the electronic training content vector so that the electronic training content is appropriately assigned in the future, determine that more basic electronic training content should be assigned before the previously assigned training content is assigned to a driver in the future, alter how the training content is assigned in stages 814 and 816, or the like to improve training assignments in the future. The server 120 may make these changes to lower the rate that drivers fail training assignments, are provided the incorrect training, or are assigned the correct training, and therefore improve training.

In stage 826, a new training assignment is generated based on the additional training content identified in stage 822. For example, the training assignment processor 127 generates one or more new training assignments for one or more drivers based on the additionally identified training content.

In stage 828, the new training assignment that is generated in stage 816 is provided to the driver. For example, the training assignment processor 127 causes the new assigned training for each of the one or more drivers to be sent to computing devices 140, 142, 144 that are associated with driver that is assigned the training. In another example, the training assignment processor 127 causes the new training to be assigned via a training interface, including the interface shown in FIG. 9 for example, that can be accessed by the driver assigned the training.

Flow may proceed back to stage 820 so that the system continues to assign new training as the driver continues to complete assigned training. Method 800, and any other method described herein may be performed in a different order and/or with additional or fewer stages.

FIG. 9 depicts an example user interface 900 in accordance with examples of the present disclosure. The user interface 900 is used by a user to complete assigned training that may be assigned by server 120 according to method 800. The user interface 900 may be a graphical user interface of a system that is used to present training to drivers. For example, the server 120 may execute the system of the user interface 900, and the user can access the system via computing device 140, 142, 144. The user interface may include one or more graphical control elements that a user may interact with. Some example graphical control elements are described herein.

The user interface 900 includes a user ID 902 that may be displayed to indicate which user the user interface is displaying training for. A user may log in to the system to access the correct training assignments assigned to the user.

The user interface 900 includes page buttons 904 that can be selected by the user to access different portions of the system. For example, the home button can be selected to direct the user to a home user interface, the assignments button can be selected to direct the user to the illustrated user interface 900, and the upload button can be selected to display a user interface that allows the user to upload documents including, for example, data related to driver behavior, via upload system 510 for example.

The assigned training section 906 displays the training assigned to the user indicated by user ID 902. The assigned training section 906 may include buttons that can be selected by the user to begin the selected training. For example, the user can select the “speeding” training shown, and the associated training can begin.

The completed training section 908 displays the training completed by the user. The completed training section 908 may include buttons that can be selected by the user to review and/or retake the selected training. For example, the user can select the “failure to yield” training shown and review the fifteen questions that were completed to see which questions were answered correctly and which questions were answered incorrectly. Additionally, the user may select the failure to yield training to retake the training. Retaking the training may be possible if the user fails a training and needs further training on the topic. In some examples, reviewing and/or retaking the training is monitored by the training progress processor 128 and included in the training progress and results feedback sent to other processors of server 120 for assigning new training.

The multimedia interface 910 displays training content of the selected training. For example, the multimedia interface 910 may display video, audio, text, and/or some other form of training content. The interactive interface 912 may display interactive content including, for example, questions and answer choices that are associated with the training. Some assigned trainings may only include multimedia content or only include interactive content.

FIG. 10 depicts an example method 1000 associated with completing training using the user interface 900 shown in FIG. 9. A user may access the user interface 900 to upload driver behavior data, view assigned training, complete assigned training, view training results, or the like.

Method 1000 begins in stage 1002, and driver behavior data is uploaded. The user may select the page button 904 labelled ‘upload’ to upload any driver behavior data related to the user. The driver behavior data uploaded by the user may be stored on a user device associated with the user and/or from external data sources including, for example, data sources 150, 152, 154, 156, 157, 158. The driver behavior data may be uploaded by the user and/or automatically accessed by the server 120. The system can determine if the user should be assigned training, for example, according to method 800 in response to the driver behavior data being uploaded. Any training that is assigned may be viewed by the user in the assigned training section 906.

In stage 1004, the training assignment processor 127 can select training. For example, the user selects a training from the assigned training section 906 of the user interface 900. In the illustrated example, the user may select the training related to speeding or the training related to unsafe turning. In response to the user selecting the training, the system may provide the training to the user, for example, a video or interactive media in the multimedia interface 910 and/or the interactive interface 912.

Once the training is selected in stage 1004, user participates in the training in stage 1006. The user may participate in the training by watching videos, listening to audio, reading textual information, interacting with interactive content or the like. The system displays the training as required in the multimedia section 910 and/or the interactive section 912. In response to the user selecting inputs on the multimedia interface 910 an/or the interactive interface 912, the system may progress through the training, score the user based on responses or actions performed in response to interactive content, and/or cause other training operations to be performed.

In stage 1008, the user views the results of training. The user may receive a notification on whether the user passed or failed in response to completing the training. The user may also review the training content and/or the answers to the interactive content. The user interface may display the correct answers and the user's selected answers so the user can review parts of the training that he or she did not understand.

Method 1000 may then return to stage 1002. The user may upload the results of the training to update the driver behavior data associated with the user. In an example, the system 120 automatically uploads the results. Additionally, the user and/or the system may automatically upload new driver behavior data. The new driver behavior data may refine the method of assigning and providing training, e.g., method 800. For example, the driver may have passed the training related to speeding but subsequently received a speeding ticket. The system may evaluate the training content, the driver behavior data, and/or other factors to determine why the training did not alter the user's behavior and/or determine additional training related to speeding. The training assignment processor 127 may then assign new training in response to the upload of driver behavior data and continue through the operations of method 1000.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more implementations, configurations, or aspects for the purpose of streamlining the disclosure. The features of the implementations, configurations, or aspects of the disclosure may be combined in alternate implementations, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed implementation, configuration, or aspect. Thus, the following claims are hereby incorporated into this Detailed Description, with each claim standing on its own as a separate preferred implementation of the disclosure.

Moreover, though the description of the disclosure has included description of one or more implementations, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative implementations, configurations, or aspects to the extent permitted, including alternate, interchangeable and/or equivalent structures, functions, ranges, or operations to those claimed, whether or not such alternate, interchangeable and/or equivalent structures, functions, ranges, or operations are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an implementation that is entirely hardware, an implementation that is entirely software (including firmware, resident software, micro-code, etc.) or an implementation combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a Random Access Memory (RAM), a Read-Only Memory (ROM), an Erasable Programmable Read-Only Memory (EPROM) (or Flash memory), an optical fiber, a portable Compact Disc Read-Only Memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, Radio Frequency (RF), etc., or any suitable combination of the foregoing.

The terms “determine,” “calculate,” “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all the equivalents thereof. Further, the structures, materials or acts and the equivalents thereof shall include all those described in the summary, brief description of the drawings, detailed description, abstract, and claims themselves.

Aspects of the present disclosure include a method for assigning training content to a driver, comprising: receiving electronic training content; processing the electronic training content to produce tokenized electronic training content; processing the tokenized electronic training content to produce electronic training content vectors; receiving driver behavior data associated with the driver; processing the driver behavior data to produce tokenized driver behavior data; processing the tokenized driver behavior data to produce driver behavior data vectors; evaluating the electronic training content vectors and the driver behavior data vectors to identify training content of the electronic training content relevant to the driver; generating a training assignment based on the identified training content; and providing the training assignment to the driver.

Any of the one or more above aspects, wherein: the electronic training content is received from a training content database; and the driver behavior data is received from an operator database.

Any of the one or more above aspects, wherein the electronic training content and the driver behavior data is received from an external data source.

Any of the one or more above aspects, wherein processing the electronic training content to produce tokenized electronic training content comprises: creating tokens from the electronic training content; and processing the electronic training content using an algorithm to assign a value to at least one token of the created tokens.

Any of the one or more above aspects, wherein the algorithm is a term frequency-inverse document frequency algorithm.

Any of the one or more above aspects, wherein processing the driver behavior data to produce the tokenized driver behavior data comprises: creating tokens from the driver behavior data; and processing the driver behavior data using an algorithm to assign a value to at least one token of the created tokens.

Any of the one or more above aspects, wherein the algorithm is a term frequency-inverse document frequency algorithm.

Any of the one or more above aspects, wherein: the electronic training content vectors include a rank of electronic training topics and an electronic training content fingerprint; and the driver behavior data vectors include a rank of driver behavior data topics and a driver behavior data fingerprint.

Any of the one or more above aspects, wherein: the electronic training content vectors include at least one dimension; and the driver behavior data vectors include at least one dimension.

Any of the one or more above aspects, wherein evaluating the electronic training content vectors and the driver behavior data vectors to identify training content of the electronic training content relevant to the driver comprises: calculating distances between the electronic training content vectors and the driver behavior data vectors based on a value of each dimension of the electronic training content vectors and a value of each dimension of the driver behavior data vectors; and identifying content based on the calculated distances.

Any of the one or more above aspects, wherein evaluating the electronic training content vectors and the driver behavior data vectors to identify training content of the electronic training content relevant to the driver further comprises assigning a weight to at least one dimension of the driver behavior data vectors.

Any of the one or more above aspects, wherein evaluating the electronic training content vectors and the driver behavior data vectors to identify training content of the electronic training content relevant to the driver further comprises assigning a weight to at least one dimension of the electronic training content vectors.

Any of the one or more above aspects, wherein the electronic training content vectors and the driver behavior data vectors . . . .

Any of the one or more above aspects, wherein evaluating the electronic training content vectors and the driver behavior data vectors comprises determining that one of the electronic training content vectors is correlated with one of the driver behavior data vectors.

Any of the one or more above aspects, wherein the identified training content comprises the electronic training content of the electronic training content vector that is correlated with one of the driver behavior data vectors.

Any of the one or more above aspects, further comprising: receiving feedback of a performance of the driver of the provided training assignment; reevaluating the electronic training content vectors and the driver behavior data vectors to identify additional training content relevant to the driver based on the feedback; generating a new training assignment based on the identified additional training content; and providing the new training assignment to the driver.

Any of the one or more above aspects, wherein generating the new training assignment based on the identified additional training content comprises including at least one identified training content document in the training assignment.

Any of the one or more above aspects, wherein the identified additional training content comprises a portion of the identified training content.

Any of the one or more above aspects, wherein the driver behavior data comprises one of: a motor vehicle report; a telematics event datapoint; a claim datapoint; a court datapoint; or a combination thereof.

Other aspects of the present disclosure include a system for assigning content to a driver, comprising: a server operable to: receive electronic training content; and receive driver behavior data associated with the driver, wherein the server comprises: a natural language processor operable to process the electronic training content to produce tokenized electronic training content, and process the driver behavior data to produce tokenized driver behavior data; a document analysis processor operable to process the tokenized electronic training content to produce electronic training content vectors, and process the tokenized driver behavior data to produce driver behavior data vectors; and a training assignment processor operable: to evaluate the electronic training content vectors and the driver behavior data vectors to identify training content of the electronic training content relevant to the driver; and generate a training assignment based on the identified training content; wherein the server is further operable to provide the training assignment to the driver.

Any of the one or more above aspects, wherein the server further comprises: an audio and speech recognition processor operable process an audio portion of electronic training content to prepare the electronic training content for processing by the natural language processor; and a training script processor operable to process a script of electronic training content to prepare the electronic training content for processing by the natural language processor.

Any of the one or more above aspects, wherein the server further comprises a training progress processor that monitors progress and results of the training assignment generated by the training assignment processor.

Any of the one or more above aspects, wherein: the training progress processor is further operable to send feedback comprising the progress and results of the training assignment to the training assignment processor; and the training assignment processor is further operable to: reevaluate the electronic training content vectors and the driver behavior data vectors based on the feedback to identify additional training content relevant to the driver; generate a new training assignment based on the identified additional training content; and provide the new training assignment to the driver.

Other aspects of the present disclosure include a system for assigning training content to a driver, comprising a processor and a memory storing instructions that, when executed by the processor, cause the system to: receive electronic training content; process the electronic training content to produce tokenized electronic training content; analyze the tokenized electronic training content to produce electronic training content vectors; receive behavior data associated with the driver; process the driver behavior data to produce tokenized driver behavior data; analyze the tokenized driver behavior data to produce driver behavior data vectors; evaluate the electronic training content vectors and the driver behavior data vectors to identify training content of the electronic training content relevant to the driver; generate a training assignment based on the identified training content; and provide the training assignment to the driver.

Other aspects of the present disclosure include a method for assigning training content to a driver, comprising: receiving electronic training content; processing the electronic training content to produce tokenized electronic training content; processing the tokenized electronic training content to produce prepared electronic training content; receiving driver behavior data associated with the driver; processing the driver behavior data to produce tokenized driver behavior data; processing the tokenized driver behavior data to produce prepared driver behavior data; evaluating the prepared electronic training content and the prepared driver behavior data to identify training content of the electronic training content relevant to the driver; generating a training assignment based on the identified training content; and providing the training assignment to the driver.

Other aspects of the present disclosure include a method for assigning training content to a driver, comprising: receiving electronic training content; processing the electronic training content to produce tokenized electronic training content; processing the tokenized electronic training content to produce prepared electronic training content; receiving a driver behavior data document associated with the driver; processing the driver behavior data document to produce a tokenized driver behavior data document; processing the tokenized driver behavior data document to produce a prepared driver behavior data document; evaluating the prepared electronic training content and the prepared driver behavior data document to identify training content of the electronic training content relevant to the driver; generating a training assignment based on the identified training content; and providing the training assignment to the driver.

Other aspects of the present disclosure include a method for assigning training content to a driver, comprising: receiving electronic training content; processing the electronic training content to produce tokenized electronic training content; processing the tokenized electronic training content to produce electronic training content fingerprints; receiving driver behavior data associated with the driver; processing the driver behavior data to produce tokenized driver behavior data; processing the tokenized driver behavior data to produce driver behavior data fingerprints; evaluating the electronic training content fingerprints and the driver behavior data fingerprints to identify training content of the electronic training content relevant to the driver; generating a training assignment based on the identified training content; and providing the training assignment to the driver.

Other aspects of the present disclosure include a method for assigning training content to a driver, comprising: receiving electronic training content; processing the electronic training content document to produce tokenized electronic training; processing the tokenized electronic training content to produce electronic training content vectors; receiving a driver behavior data document associated with the driver; processing the driver behavior data document to produce a tokenized driver behavior data document; processing the tokenized driver behavior data document to produce a driver behavior data vector; evaluating the electronic training content vectors and the driver behavior data vector to identify training content of the electronic training content relevant to the driver; generating a training assignment based on the identified training content; and providing the training assignment to the driver.

Other aspects of the present disclosure include a method for assigning training content to a driver, comprising: receiving electronic training content; processing the electronic training content to produce tokenized electronic training; processing the tokenized electronic training content to produce electronic training content fingerprints; receiving a behavior data document associated with the driver; processing the driver behavior data document to produce a tokenized driver behavior data document; processing the tokenized driver behavior data document to produce a driver behavior data fingerprint; evaluating the electronic training content fingerprints and the driver behavior data fingerprint to identify training content of the electronic training content relevant to the driver; generating a training assignment based on the identified training content; and providing the training assignment to the driver.

Other aspects of the present disclosure include a computer-implemented method of assigning and providing training to a driver, the method comprising: displaying on a user device associated with the driver a user interface comprising a plurality of graphical control elements for completing assigned training, the graphical control elements comprising a multimedia interface and an interactive interface; determining a selected training that is assigned to the driver; in response to determining the selected training, displaying electronic training content associated with the selected training via the multimedia interface, the interactive interface, or a combination thereof; receiving an input from the user via the multimedia interface, the interactive interface, or a combination thereof; progressing through the electronic training content in response to the input; and in response to the driver completing the selected training, displaying via the user interface results of the training.

Any of the one or more aspects herein, wherein the components are one or more of an ASIC, a processor, a memory, a FPGA, a SOC, or a physically separate device.

A means of or for any of the one or more aspects herein.

A system, component, hardware, software, data, user interfaces, signals or signaling processes and systems, etc. for conducting any of the one or more aspects herein.

Any of the one or more aspects herein in combination with any of the other one or more above aspects.

What is claimed is:

1. A method for assigning training content to a driver, comprising:
receiving electronic training content;
processing the electronic training content to produce tokenized electronic training content;
processing the tokenized electronic training content to produce electronic training content vectors;
receiving driver behavior data associated with the driver;
processing the driver behavior data to produce tokenized driver behavior data;
processing the tokenized driver behavior data to produce driver behavior data vectors;
evaluating the electronic training content vectors and the driver behavior data vectors to identify training content of the electronic training content relevant to the driver;
generating a training assignment based on the identified training content; and
providing the training assignment to the driver.

2. The method of claim 1, wherein:
the electronic training content is received from a training content database; and
the driver behavior data is received from an operator database.

3. The method of claim 1, wherein the electronic training content and the driver behavior data is received from an external data source.

4. The method of claim 1, wherein processing the electronic training content to produce tokenized electronic training content comprises:
creating tokens from the electronic training content; and
processing the electronic training content using an algorithm to assign a value to at least one token of the created tokens.

5. The method of claim 4, wherein the algorithm is a term frequency-inverse document frequency algorithm.

6. The method of claim 1, wherein processing the driver behavior data to produce the tokenized driver behavior data comprises:
creating tokens from the driver behavior data; and
processing the driver behavior data using an algorithm to assign a value to at least one token of the created tokens.

7. The method of claim 6, wherein the algorithm is a term frequency-inverse document frequency algorithm.

8. The method of claim 1, wherein:
the electronic training content vectors include a rank of electronic training topics and an electronic training content fingerprint; and
the driver behavior data vectors include a rank of driver behavior data topics and a driver behavior data fingerprint.

9. The method of claim 1, wherein:
the electronic training content vectors include at least one dimension; and
the driver behavior data vectors include at least one dimension.

10. The method of claim 9, wherein evaluating the electronic training content vectors and the driver behavior data vectors to identify training content of the electronic training content relevant to the driver comprises:
calculating distances between the electronic training content vectors and the driver behavior data vectors based on a value of each dimension of the electronic training content vectors and a value of each dimension of the driver behavior data vectors; and
identifying content based on the calculated distances.

11. The method of claim 10, wherein evaluating the electronic training content vectors and the driver behavior data vectors to identify training content of the electronic training content relevant to the driver further comprises assigning a weight to at least one dimension of the driver behavior data vectors.

12. The method of claim 10, wherein evaluating the electronic training content vectors and the driver behavior data vectors to identify training content of the electronic training content relevant to the driver further comprises assigning a weight to at least one dimension of the electronic training content vectors.

13. The method of claim 1, wherein the electronic training content vectors and the driver behavior data vectors.

14. The method of claim 1, wherein evaluating the electronic training content vectors and the driver behavior data vectors comprises determining that one of the electronic training content vectors is correlated with one of the driver behavior data vectors.

15. The method of claim 14, wherein the identified training content comprises the electronic training content of the electronic training content vector that is correlated with one of the driver behavior data vectors.

16. The method of claim 1, further comprising:
receiving feedback of a performance of the driver of the provided training assignment;
reevaluating the electronic training content vectors and the driver behavior data vectors to identify additional training content relevant to the driver based on the feedback;
generating a new training assignment based on the identified additional training content; and
providing the new training assignment to the driver.

17. The method of claim 16, wherein generating the new training assignment based on the identified additional training content comprises including at least one identified training content document in the training assignment.

18. The method of claim 16, wherein the identified additional training content comprises a portion of the identified training content.

19. The method of claim 1, wherein the driver behavior data comprises one of:
a motor vehicle report;
a telematics event datapoint;
a claim datapoint;
a court datapoint; or
a combination thereof.

20. A system for assigning content to a driver, comprising:
a server operable to:
receive electronic training content; and
receive driver behavior data associated with the driver,
wherein the server comprises:
a natural language processor operable to process the electronic training content to produce tokenized electronic training content, and process the driver behavior data to produce tokenized driver behavior data;
a document analysis processor operable to process the tokenized electronic training content to produce electronic training content vectors, and process the tokenized driver behavior data to produce driver behavior data vectors; and
a training assignment processor operable:
to evaluate the electronic training content vectors and the driver behavior data vectors to identify training content of the electronic training content relevant to the driver; and
generate a training assignment based on the identified training content;
wherein the server is further operable to provide the training assignment to the driver.

21. The system of claim 20, wherein the server further comprises:
an audio and speech recognition processor operable process an audio portion of electronic training content to prepare the electronic training content for processing by the natural language processor; and
a training script processor operable to process a script of electronic training content to prepare the electronic training content for processing by the natural language processor.

22. The system of claim 20, wherein the server further comprises a training progress processor that monitors progress and results of the training assignment generated by the training assignment processor.

23. The system of claim 22, wherein:
the training progress processor is further operable to send feedback comprising the progress and results of the training assignment to the training assignment processor; and
the training assignment processor is further operable to:
reevaluate the electronic training content vectors and the driver behavior data vectors based on the feedback to identify additional training content relevant to the driver;
generate a new training assignment based on the identified additional training content; and
provide the new training assignment to the driver.

24. A system for assigning training content to a driver, comprising a processor and a memory storing instructions that, when executed by the processor, cause the system to:
receive electronic training content;
process the electronic training content to produce tokenized electronic training content;
analyze the tokenized electronic training content to produce electronic training content vectors;
receive behavior data associated with the driver;
process the driver behavior data to produce tokenized driver behavior data;
analyze the tokenized driver behavior data to produce driver behavior data vectors;
evaluate the electronic training content vectors and the driver behavior data vectors to identify training content of the electronic training content relevant to the driver;
generate a training assignment based on the identified training content; and
provide the training assignment to the driver.

25. A method for assigning training content to a driver, comprising:
receiving electronic training content;
processing the electronic training content to produce tokenized electronic training content;
processing the tokenized electronic training content to produce prepared electronic training content;
receiving driver behavior data associated with the driver;
processing the driver behavior data to produce tokenized driver behavior data;
processing the tokenized driver behavior data to produce prepared driver behavior data;
evaluating the prepared electronic training content and the prepared driver behavior data to identify training content of the electronic training content relevant to the driver;
generating a training assignment based on the identified training content; and
providing the training assignment to the driver.

26. A method for assigning training content to a driver, comprising:
receiving electronic training content;
processing the electronic training content to produce tokenized electronic training content;
processing the tokenized electronic training content to produce prepared electronic training content;
receiving a driver behavior data document associated with the driver;
processing the driver behavior data document to produce a tokenized driver behavior data document;
processing the tokenized driver behavior data document to produce a prepared driver behavior data document;
evaluating the prepared electronic training content and the prepared driver behavior data document to identify training content of the electronic training content relevant to the driver;
generating a training assignment based on the identified training content; and
providing the training assignment to the driver.

27. A method for assigning training content to a driver, comprising:
receiving electronic training content;
processing the electronic training content to produce tokenized electronic training content;
processing the tokenized electronic training content to produce electronic training content fingerprints;
receiving driver behavior data associated with the driver;
processing the driver behavior data to produce tokenized driver behavior data;
processing the tokenized driver behavior data to produce driver behavior data fingerprints;
evaluating the electronic training content fingerprints and the driver behavior data fingerprints to identify training content of the electronic training content relevant to the driver;
generating a training assignment based on the identified training content; and
providing the training assignment to the driver.

28. A method for assigning training content to a driver, comprising:
receiving electronic training content;
processing the electronic training content document to produce tokenized electronic training;
processing the tokenized electronic training content to produce electronic training content vectors;
receiving a driver behavior data document associated with the driver;
processing the driver behavior data document to produce a tokenized driver behavior data document;
processing the tokenized driver behavior data document to produce a driver behavior data vector;
evaluating the electronic training content vectors and the driver behavior data vector to identify training content of the electronic training content relevant to the driver;
generating a training assignment based on the identified training content; and
providing the training assignment to the driver.

29. A method for assigning training content to a driver, comprising:
receiving electronic training content;
processing the electronic training content to produce tokenized electronic training;
processing the tokenized electronic training content to produce electronic training content fingerprints;
receiving a behavior data document associated with the driver;
processing the driver behavior data document to produce a tokenized driver behavior data document;
processing the tokenized driver behavior data document to produce a driver behavior data fingerprint;
evaluating the electronic training content fingerprints and the driver behavior data fingerprint to identify training content of the electronic training content relevant to the driver;
generating a training assignment based on the identified training content; and
providing the training assignment to the driver.

30. A computer-implemented method of assigning and providing training to a driver, the method comprising:
displaying on a user device associated with the driver a user interface comprising a plurality of graphical control elements for completing assigned training, the graphical control elements comprising a multimedia interface and an interactive interface;
determining a selected training that is assigned to the driver;
in response to determining the selected training, displaying electronic training content associated with the selected training via the multimedia interface, the interactive interface, or a combination thereof;
receiving an input from the user via the multimedia interface, the interactive interface, or a combination thereof;
progressing through the electronic training content in response to the input; and
in response to the driver completing the selected training, displaying via the user interface results of the training.
